(19) United States
(12) Patent Application Publication
(10) Pub. No.: US 2024/0370604 A1
(43) Pub. Date: Nov. 7, 2024

(54) METHOD AND APPARATUS FOR OPTIMALLY CONFIGURING CAPACITY OF HIGH-PROPORTION NEW ENERGY SYSTEM, DEVICE, AND MEDIUM

(71) Applicants: SHANDONG UNIVERSITY, Jinan (CN); NORTH CHINA ELECTRIC POWER UNIVERSITY, Beijing (CN); SHANGHAI JIAO TONG UNIVERSITY, Shanghai (CN); CHINA ELECTRIC POWER RESEARCH INSTITUTE, Beijing (CN)

(72) Inventors: Tianguang LV, Jinan (CN); Jing Li, Jinan (CN); Fei Wang, Beijing (CN); Zhaohao Ding, Beijing (CN); Xing He, Shanghai (CN); Wanxing Sheng, Beijing (CN); Rui Li, Beijing (CN); Haoyuan Cheng, Shanghai (CN); Qian Ai, Shanghai (CN); Ming Yang, Jinan (CN); Xueshan Han, Jinan (CN); Guibin Zou, Jinan (CN); Chengfu Wang, Jinan (CN)

(73) Assignees: SHANDONG UNIVERSITY, Jinan (CN); NORTH CHINA ELECTRIC POWER UNIVERSITY, Beijing (CN); SHANGHAI JIAO TONG UNIVERSITY, Shanghai (CN); CHINA ELECTRIC POWER RESEARCH INSTITUTE, Beijing (CN)

(21) Appl. No.: 18/436,783

(22) Filed: Feb. 8, 2024

(30) Foreign Application Priority Data
May 4, 2023 (CN) 2023104830852

(51) Int. Cl. G06F 30/20

(52) U.S. Cl. CPC G06F 30/20

(57) ABSTRACT

A method and apparatus for optimally configuring a capacity of a high-proportion new energy system, a device, and a medium, which belong to the field of new energy system optimization and are used for solving the problems of insufficient flexibility of the high-proportion new energy system during the heating period and difficult consumption of renewable energy. The method includes: constructing a high-proportion new energy system structure; establishing a concentrating solar power (CSP) unit model and a combined heat and power (CHP) unit model based on the proposed structure; establishing a high-proportion new energy system collaborative optimization model based on the proposed unit models; acquiring relevant data of various units and renewable resource data; and obtaining a capacity configuration and operation optimization scheme of various units in the high-proportion new energy system according to the established model, thereby improving the renewable energy consumption of the system.

### CROSS-REFERENCE TO RELATED APPLICATIONS

The present invention claims priority to Chinese Patent Application No. 202310483085.2, filed to the China National Intellectual Property Administration on May 4, 2023, entitled “METHOD AND APPARATUS FOR OPTIMALLY CONFIGURING CAPACITY OF HIGH-PROPORTION NEW ENERGY SYSTEM, DEVICE, AND MEDIUM”, the entire contents of which are incorporated herein by reference.

### TECHNICAL FIELD

The present invention belongs to the field of new energy system optimization, and more particularly, to a method and apparatus for optimally configuring a capacity of a high-proportion new energy system, a device, and a medium.

### BACKGROUND

It is an important way to realize clean and low-carbon energy supply by promoting the construction of a high-proportion new energy system. However, the randomness and volatility of renewable energy such as wind energy and solar energy will have a great impact on the safety and operation flexibility of the high-proportion new energy system. An energy supply system includes new energy and combined heat and power (CHP) units. The increasing proportion of the new energy units in the energy supply system and the operation characteristics of the CHP units “determining power by heat” (that is, determining an electric energy output according to a heat energy output) will lead to the lack of flexibility of the high-proportion new energy system, thus causing a large number of renewable energy to be reduced. Especially the phenomenon of abandoning wind and solar during the heating period in winter will be more serious.

In recent years, the curtailment rate of available wind energy and solar energy during the heating period in winter in Northwest China is more than 20%. Therefore, the problems of insufficient flexibility and difficult consumption of renewable energy during the heating period of the high-proportion new energy system need to be solved urgently.

### SUMMARY

In order to overcome the deficiencies of the related art, the present invention provides a method for optimally configuring a capacity of a high-proportion new energy system based on CSP-CHP combined energy supply. CSP represents concentrating solar power, and CHP represents combined heat and power. The method can effectively improve the operation flexibility of the high-proportion new energy system during the heating period, thereby improving the renewable energy consumption capability of the system, reducing wind and solar abandonment, promoting decarburization of the system, and realizing flexible and low-carbon operation of the high-proportion new energy system.

In order to achieve the above object, one or more embodiments of the present invention provide the following technical solutions.

In a first aspect, a method for optimally configuring a capacity of a high-proportion new energy system is disclosed. The method is performed by a processor of an intelligent management platform of an energy system for realizing capacity planning and operation optimization of various units. The method includes:
constructing, based on a CSP unit and a CHP unit, a high-proportion new energy system structure based on CSP-CHP combined energy supply;
establishing a CSP unit model and a CHP unit model based on the constructed high-proportion new energy system structure;
establishing, based on the CSP unit model and the CHP unit model, a high-proportion new energy system collaborative optimization model based on CSP-CHP combined energy supply;
acquiring operating parameters of various units, cost data of various units, and wind and solar resource data of a planned region, inputting the acquired operating parameters of various units, cost data of various units, and wind and solar resource data of the planned region into the high-proportion new energy system collaborative optimization model based on CSP-CHP combined energy supply, and solving the high-proportion new energy system collaborative optimization model based on CSP-CHP combined energy supply to obtain capacity configurations of various units in the high-proportion new energy system; and
sending a final configuration scheme for capacity planning and operation optimization to a display for display, so as to realize the capacity optimization configuration of the high-proportion new energy system.

As a further technical solution, in the high-proportion new energy system structure based on CSP-CHP combined energy supply, the CSP unit includes:
a solar concentrating and heat collecting part, respectively connected to a heat storage part and a power generation part, where the solar concentrating and heat collecting part is configured to absorb solar energy, convert the solar energy into heat energy through a heat transfer fluid, and transmit the heat energy to the heat storage part and the power generation part respectively;
the heat storage part, smoothing an unstable power outputted by a generator by storing the heat energy and responding to a heat demand; and
the power generation part, respectively connected to the solar concentrating and heat collecting part and a waste heat boiler in the CHP unit to convert the heat energy into electric energy.

As a further technical solution, the CSP unit model includes a constraint of heat energy balance, a constraint of solar concentrating and heat collecting link, a constraint of heat storage link, a constraint of power generation link, and a constraint of flexibility of the CSP unit.

As a further technical solution, the CHP unit model includes a constraint of heat power output, a constraint of electric power output, and a constraint of flexibility of the CHP unit.

As a further technical solution, the high-proportion new energy system collaborative optimization model based on CSP-CHP combined energy supply includes an objective function and constraints.

The objective function is to minimize the total cost of the high-proportion new energy system.

The constraints include a constraint of investment and operation decisions, a constraint of system electric power balance, a constraint of system heat power balance, a system reserve constraint, and a constraint of low-carbon policy.

As a further technical solution, when the high-proportion new energy system collaborative optimization model based on CSP-CHP combined energy supply is solved, it is necessary to acquire rated capacity data of a coal-fired power generation unit, a wind power generation unit, a photovoltaic power generation unit, the CSP unit, and the CHP unit, rated operating parameters of various units, including a power output limit and a climbing rate limit, investment costs, fixed operation and maintenance costs, fuel costs, and start-stop costs of various units, and wind and solar resource data of the planned region.

The acquired data is inputted into the high-proportion new energy system collaborative optimization model based on CSP-CHP combined energy supply, and outputted as new capacities and hourly electric power outputs of the coal-fired power generation unit, the wind power generation unit, the photovoltaic power generation unit, the CSP unit, and the CHP unit, hourly heat power outputs of the CSP unit and the CHP unit, and a renewable energy reduction rate of the system.

As a further technical solution, the model is solved using a GUROBI solver.

In a second aspect, an apparatus for optimally configuring a capacity of a high-proportion new energy system based on CSP-CHP combined supply is disclosed. The apparatus includes:
a system structure construction module, configured to construct a high-proportion new energy system structure based on CSP-CHP combined energy supply, where CSP represents concentrating solar power, and CHP represents combined heat and power;
a unit model establishment module, configured to establish a CSP unit model and a CHP unit model based on the constructed high-proportion new energy system structure;
a collaborative optimization model establishment module, configured to establish, based on the constructed unit models, a high-proportion new energy system collaborative optimization model based on CSP-CHP combined energy supply; and
a solving module, configured to acquire rated capacities and rated operating parameters of various units, investment costs, fixed operation and maintenance costs, fuel costs, and start-stop costs of various units, and wind and solar resource data of the planned region, and obtain a capacity configuration and operation optimization scheme of various units in the high-proportion new energy system according to the acquired data and the established high-proportion new energy system collaborative optimization model based on CSP-CHP combined energy supply.

The above one or more technical solutions have the following beneficial effects.

According to the technical solutions of the present invention, when a high-proportion new energy system collaborative optimization model based on CSP-CHP combined energy supply is established, a CSP unit model and a CHP unit model are respectively established based on a constructed high-proportion new energy system structure based on CSP-CHP combined energy supply. A CSP unit generally includes a heat storage part. Thus the uncertainty of wind energy and photovoltaic power generation can be effectively reduced while supplying clean and renewable electric energy and heat energy. In addition to flexible power output, the CSP unit may also expand the operation range of a CHP unit through the heat storage part, thus alleviating the operation constraint of “determining power by heat” of the CHP unit. Therefore, by establishing the high-proportion new energy system collaborative optimization model based on CSP-CHP combined energy supply, a capacity configuration and operation optimization scheme of various units in the high-proportion new energy system is obtained. The operation flexibility of the high-proportion new energy system during the heating period can be effectively improved, thereby improving the renewable energy consumption capability of the system, reducing wind and solar abandonment, promoting decarburization of the system, reducing the investment and operation costs of the system, and realizing flexible and low-carbon economic operation of the high-proportion new energy system.

The advantages of additional aspects of the present invention will be set forth in part in the following description which will become apparent in part from the following description or will become apparent from the practice of the present invention.

### BRIEF DESCRIPTION OF THE DRAWINGS

The accompanying drawings, which constitute a part of the present invention, serve to provide a further understanding of the present invention, and schematic embodiments of the present invention and the descriptions thereof serve to explain the present invention and are not to be construed as unduly limiting the present invention.

FIG. 1 is a diagram of a high-proportion new energy system structure based on CSP-CHP combined energy supply according to an embodiment of the present invention.

FIG. 2 is a schematic diagram of a CSP operation energy flow considering CSP-CHP combined energy supply according to an embodiment of the present invention.

FIG. 3 is a schematic diagram of a CHP operation range considering CSP-CHP combined energy supply according to an embodiment of the present invention.

In FIG. 3, a part contained in ABCD represents an operation range of a CHP unit without considering combined energy supply with a CSP unit traditionally. A part contained in AA′B′C′CD represents an operation range of the CHP unit after introducing the CSP unit to participate in combined energy supply. Pₘₐₓ represents a maximum value of an electric energy output of the CHP unit when a heat energy output is 0. Pₘᵢₙ represents a minimum value of the electric energy output of the CHP unit when the heat energy output is 0. P_{E1} represents a maximum value of the electric energy output of the CHP unit when the heat energy output is Q_{E} without considering combined energy supply with the CSP unit traditionally. P_{E2} represents a minimum value of the electric energy output of the CHP unit when the heat energy output is Q_{E} without considering combined energy supply with the CSP unit traditionally. P_{E1′} represents a maximum value of the electric energy output of the CHP unit when the heat energy output is Q_{E} after introducing the CSP unit to participate in combined energy supply. P_{E2′} represents a minimum value of the electric energy output of the CHP unit when the heat energy output is Q_{E} after introducing the CSP unit to participate in combined energy supply. Qₒᵤₜ represents heat energy outputted by a heat storage part of the CSP unit. Qₘᵢₙ represents a minimum value of the heat energy output of the CHP unit without considering combined energy supply with the CSP unit traditionally. Qₘₐₓ represents a maximum value of the heat energy output of the CHP unit without considering combined energy supply with the CSP unit traditionally. Qₘᵢₙ+Qₒᵤₜ represents a minimum value of the heat energy output of the CHP unit after introducing the CSP unit to participate in combined energy supply. Qₘₐₓ+Qₒᵤₜ represents a maximum value of the heat energy output of the CHP unit after introducing the CSP unit to participate in combined energy supply. c_{m,n} and c_{v,n} represent parameters of a feasible operation region of the CHP unit.

### DETAILED DESCRIPTION

It should be noted that the following detailed description is exemplary and is intended to provide further explanation of the present invention. Unless otherwise specified, all technical and scientific terms used in the present invention have the same meaning as commonly understood by a person of ordinary skill in the art to which the present invention belongs.

It is to be noted that the terms used herein are for the purpose of describing specific implementations only and are not intended to be limiting of exemplary implementations according to the present invention.

Embodiments in the present invention and features in the embodiments may be combined with each other without conflict.

### Embodiment 1

This embodiment discloses a method for optimally configuring a capacity of a high-proportion new energy system, which can improve the renewable energy consumption capability of the high-proportion new energy system. The method may be performed by a processor of an intelligent management platform of an energy system for realizing capacity planning and operation optimization of various units. The method includes the following steps.
Step 1: Construct a high-proportion new energy system structure based on CSP-CHP combined energy supply considering complementary advantages of combined energy supply of a CSP unit and a CHP unit.
Step 2: Establish, on the basis of step 1, an improved CSP unit model and an improved CHP unit model based on the high-proportion new energy system structure based on CSP-CHP combined energy supply considering operation characteristics of the CSP unit and the CHP unit and an improved constraint of flexibility by taking high-proportion renewable energy consumption and comprehensive economy of the system as an objective, and establish, based on the constructed unit models, a high-proportion new energy system collaborative optimization model combining capacity investments of the units and hourly energy balance of the system.
Step 3: Acquire a capacity planning and operation optimization scheme of various units capable of improving system flexibility and renewable energy consumption capability according to rated capacities of various units and the constructed high-proportion new energy system planning and operation collaborative optimization model.

In a specific implementation, a final configuration scheme for capacity planning and operation optimization may be sent to a display for display, so as to realize the capacity optimization configuration of the high-proportion new energy system.

Through the method for collaboratively optimizing a high-proportion new energy system based on CSP-CHP combined energy supply disclosed in this embodiment, the operation flexibility of the high-proportion new energy system during the heating period can be effectively improved, thereby improving the renewable energy consumption capability of the system, reducing wind and solar abandonment, promoting decarburization of the system, reducing the investment and operation costs of the system, and realizing flexible and low-carbon economic operation of the high-proportion new energy system.

In step 1, when constructing a high-proportion new energy system structure based on CSP-CHP combined energy supply:

For a wind power generation unit and a photovoltaic power generation unit, the power generation process is sensitive to the influence of wind energy and solar energy respectively, and therefore, the fluctuation is strong. The CHP unit may extract part of energy from a gas turbine to heat through a waste heat boiler, while the rest of the energy continues to generate power. However, the CHP unit has an operation constraint of “determining power by heat”, and natural gas is used as fuel. Therefore, the CHP unit still has higher carbon emissions compared with renewable energy units. The CSP unit, on the one hand, may fully compensate for the fluctuation of wind power and photovoltaic power generation through a heat storage part, and achieve the purpose of continuous and stable power generation through a steam turbine with good output power adjustability. On the other hand, the CSP unit may respond to a heat demand through the heat storage part, and expand the operation range of the CHP unit, thus alleviating the operation constraint of “determining power by heat” of the CHP unit. Also, CSP is a renewable energy power generation technology with very little carbon emissions, which can achieve the purpose of clean and low-carbon energy supply.

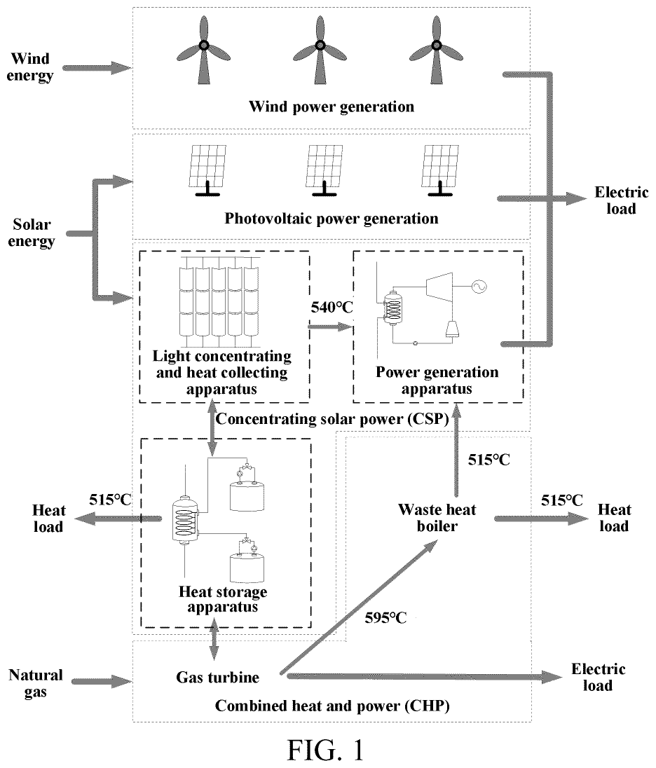

In summary, the high-proportion new energy system structure based on CSP-CHP combined energy supply is constructed considering the complementary advantages of combined energy supply of the CSP unit and the CHP unit in the present invention, as shown in FIG. 1.

In addition to a traditional coal-fired power generation unit, a wind power generation unit, a photovoltaic power generation unit, a CSP unit, and a CHP unit are mainly included. A typical CSP unit is generally composed of three parts:
(1) a solar concentrating and heat collecting part, capable of absorbing solar energy and converting the solar energy into heat energy through a heat transfer fluid;
(2) a heat storage part, capable of smoothing an unstable power outputted by a generator and responding to a heat demand by storing the heat energy, where the CHP unit and the CSP unit may be combined on the basis of the heat storage part, thereby improving the output flexibility of the CHP unit; and
(3) a power generation part, capable of converting the heat energy into electric energy through a steam turbine with good output power adjustability, and providing inertia support for an energy system. Furthermore, the power adjustment speed is higher than that of the traditional coal-fired power generation unit. Therefore, the CSP unit can quickly respond to the output power fluctuations of the wind power generation unit and the photovoltaic power generation unit, and improve the operation flexibility of a high-proportion new energy system.

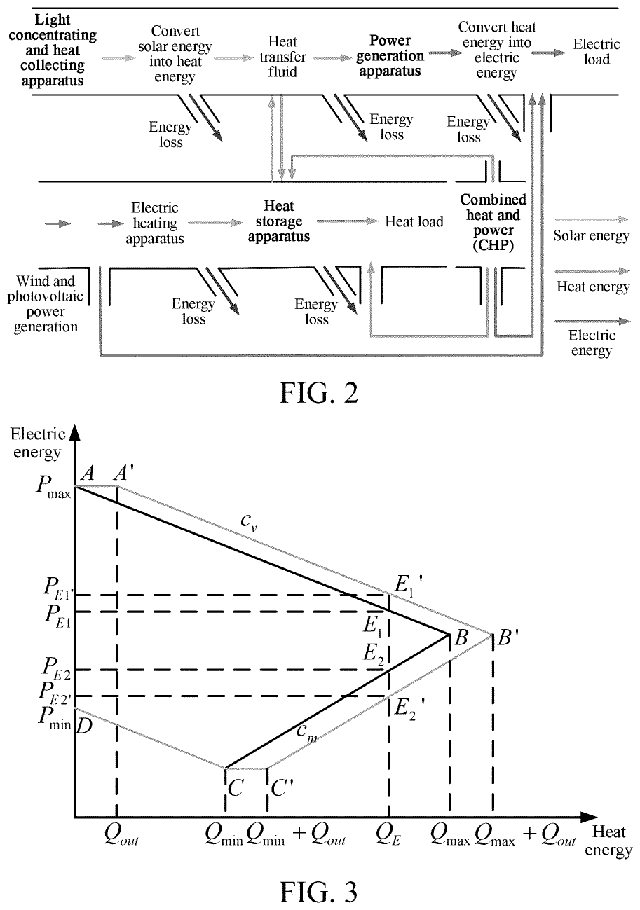

For 8760-hour collaborative optimization of a large-scale energy system, a traditional mixed integer unit combination method has a huge number of decision variables, which leads to the difficulty of optimal computation. Furthermore, to evaluate the renewable energy consumption capability and the system cost, a total output of a certain type of unit is more important. Therefore, this embodiment considers CSP-CHP combined energy supply, and establishes an improved CSP unit model based on a fast clustering optimization method and an improved linear constraint of flexibility, which can greatly improve the optimal computation efficiency. The schematic diagram of a CSP operation energy flow considering CSP-CHP combined energy supply is shown in FIG. 2.

In step 2, the improved CSP unit model includes:
(1) Constraint of heat energy balance

$${Q}_{j , t}^{SF - HTF} + {Q}_{j , t}^{TES - HTF} = {Q}_{j , t}^{HTF - TES} + {Q}_{j , t}^{HTF - PB} \qquad ( 1 )$$

where Q_{j,t}^{SF-HTF} represents a heat power transferred to a heat transfer fluid from a solar concentrating and heat collecting part of a CSP unit group j at t, Q_{j,t}^{TES-HTF} represents a heat power transferred to the heat transfer fluid from a heat storage part of the CSP unit group j at t, Q_{j,t}^{HTF-TES} represents a heat power transferred to the heat storage part from the heat transfer fluid of the CSP unit group j at t, and Q_{j,t}^{HTF-PB} represents a heat power transferred to a power generation part from the heat transfer fluid of the CSP unit group j at t.
(2) Constraint of solar concentrating and heat collecting link

$${Q}_{j , t}^{SF - HTF} = {η}_{S F} \cdot {S}_{S F} \cdot DNI - {Q}_{j , t}^{c u r} \qquad ( 2 )$$

where η_{SF} represents a solar-heat conversion efficiency factor of the solar concentrating and heat collecting part, S_{SF} represents an area of a mirror field in the solar concentrating and heat collecting part, DN1 represents a solar direct normal radiation value, and Q_{j,t}^{cur} represents energy loss in the solar concentrating and heat collecting link of the CSP unit group j at t.
(3) Constraint of heat storage link

$${Q}_{j , t}^{csp} = ( 1 - γ \cdot Δ t ) \cdot {Q}_{j , t - 1}^{csp} + ( {Q}_{j , t}^{TES , cha} - {Q}_{j , t}^{TES , dis} ) \cdot Δ t \qquad ( 3 )$$

$${Q}_{j , t}^{TES , cha} = {η}_{TES}^{cha} \cdot ( {Q}_{j , t}^{HTF - TES} + {Q}_{j , t}^{EH - TES} + {Q}_{n , t}^{chp , cur} ) \qquad ( 4 )$$

$${Q}_{j , t}^{TES , dis} = ( {Q}_{j , t}^{TES - HTF} + {Q}_{j , t}^{TES - HD} ) / {η}_{TES}^{dis} \qquad ( 5 )$$

$${Q}_{j , t}^{EH - TES} = {η}_{EH} \cdot ( {P}_{t}^{W - EH} + {P}_{t}^{S - EH} ) \qquad ( 6 )$$

$${Q}_{j , min}^{csp} \leq {Q}_{j , t}^{csp} \leq {Q}_{j , max}^{csp} \qquad ( 7 )$$

where Q_{j,t}^{esp} represents a state of charge of the heat storage part of the CSP unit group j at t, Q_{j,t}^{TES,cha} and Q_{j,t}^{TES,dis} respectively represent charged and discharged energy of the heat storage part at t, γ represents a heat dissipation rate, Δt represents a time interval, and Q_{j,t}^{esp} represents a state of charge of the heat storage part of the CSP unit group j at t−1;

Q_{j,t}^{HTF-TES} represents a heat power transferred to the heat storage part from the heat transfer fluid of the CSP unit group j at t, Q_{j,t}^{EH-TES} represents a heat power transferred to the heat storage part from an electric heating part of the CSP unit group j at t, and Q_{n,t}^{chp,cur} represents a heat power transferred to the heat storage part from a CHP unit group n at t;

Q_{j,t}^{TES-HTF} represents a heat power transferred to the heat transfer fluid from the heat storage part of the CSP unit group j at t, Q_{j,t}^{TES-HD} represents a heat power supplied to a heat load from the heat storage part of the CSP unit group j at t, and, η_{TES}^{cha} and, η_{TES}^{dis} respectively represent energy charging and discharging efficiency factors of the heat storage part;

η_{EH} represents an efficiency factor of the electric heating part, and pₜ^{W-EH} and Pₜ^{S-EH} respectively represent electric powers inputted to the electric heating part from a wind power generation unit and a photovoltaic power generation unit; and

Q_{j,min}^{csp} and Q_{j,max}^{csp} respectively represent a minimum value and a maximum value of the state of charge of the heat storage part of the CSP unit group j.
(4) Constraint of power generation link

$${Q}_{j , t}^{HTF - PB} = {P}_{j , t}^{c s p} / {η}_{P B} \qquad ( 8 )$$

where η_{PB} represents an efficiency factor of the power generation part, Q_{j,t}^{HTF-PB} represents a heat power transferred from the heat transfer fluid of the CSP unit group j to the power generation part at t, and P_{j,t}^{csp} represents an electric power output of the CSP unit group j at t.
(5) Constraint of flexibility

$${P}_{j , min}^{c s p} \leq {P}_{j , t}^{c s p} \leq {P}_{j , max}^{csp} \qquad ( 9 )$$

$${P}_{j , min}^{c s p} = {\underline{A}}_{j , t}^{c s p} \cdot {S}_{c s p , j , t}^{O} \qquad ( 10 )$$

$${P}_{j , max}^{csp} = {\overline{A}}_{j , t}^{csp} \cdot {S}_{csp , j , t}^{O} \qquad ( 11 )$$

$${P}_{j , t}^{c s p} - {P}_{j , t - 1}^{c s p} \geq {\underline{A}}_{j , t}^{c s p} \cdot {S}_{csp , j , t}^{U} - {\underline{A}}_{j , t}^{c s p} \cdot {S}_{csp , j , t}^{D} - {R}_{csp , j}^{D} ( {S}_{csp , j , t}^{O} - {S}_{csp , j , t}^{U} - {S}_{csp , j , t - 1}^{U} ) \qquad ( 12 )$$

$${P}_{j , t}^{c s p} - {P}_{j , t - 1}^{c s p} \leq {\underline{A}}_{j , t}^{c s p} \cdot {S}_{csp , j , t}^{U} - {\underline{A}}_{j , t}^{c s p} \cdot {S}_{csp , j , t}^{D} + {R}_{csp , j}^{U} ( {S}_{csp , j , t}^{O} - {S}_{csp , j , t}^{U} - {S}_{csp , j , t + 1}^{D} ) \qquad ( 13 )$$

$${P}_{j , t}^{csp} \leq {\overline{A}}_{j , t}^{csp} \cdot ( {S}_{csp , j , t}^{O} - {S}_{csp , j , t}^{U} - {S}_{csp , j , t + 1}^{D} ) + {\underline{A}}_{j , t}^{csp} \cdot {S}_{csp , j , t}^{U} + {\underline{A}}_{j , t}^{csp} \cdot {S}_{csp , j , t + 1}^{D} \qquad ( 14 )$$

$$0 \leq {S}_{csp , j , t}^{O} \leq {S}_{csp , j} \qquad ( 15 )$$

$${S}_{csp , j , t}^{O} - {S}_{csp , j , t - 1}^{O} = {S}_{csp , j , t}^{U} - {S}_{csp , j , t}^{D} \qquad ( 16 )$$

$${S}_{csp , j} = {\sum }_{i = 1}^{I} {P}_{i , max}^{csp} \qquad ( 17 )$$

where P_{j,t}^{csp} represents the electric power output of the CSP unit group j at t, P_{j,min}^{csp} represents a minimum value of an output electric power of the CSP unit group j, and P_{j,max}^{csp} represents a maximum value of the output electric power of the CSP unit group j;
   A_{j,t}^{csp} and Ā_{j,t}^{csp} respectively represent ratios of a minimum output electric power and a maximum output electric power of the CSP unit group j to a total online capacity of the CSP unit group j, and S_{csp,j,t}^{O} represents a total online capacity of the CSP unit group j at t;

P_{j,t-1}^{csp} represents an electric power output of the CSP unit group j at t−1, S_{csp,j,t}^{U} represents a total start capacity of the CSP unit group j at t, S_{csp,j,t}^{D} represents a total stop capacity of the CSP unit group j at t, R_{csp,j}^{U} and R_{csp,j,t}^{D} respectively represent a climb-up rate and a climb-down rate of the CSP unit group j, S_{csp,j,t-1}^{U} represents a total start capacity of the CSP unit group j at t−1, and S_{csp,j,t+1}^{D} represents a total stop capacity of the CSP unit group j at t+1; and

S_{csp,j,t-1}^{O} represents a total online capacity of the CSP unit group j at t−1, S_{csp,j} represents a total capacity of the CSP unit group j, and P_{i,max}^{csp} represents a maximum value of an output electric power of a CSP unit i in the CSP unit group j, and I represents the number of CSP units in the CSP unit group j.

Without considering combined energy supply with the CSP unit traditionally, the operation range of the CHP unit is small, which leads to the lack of flexibility during the heating period of a high-proportion new energy system, resulting in a large number of renewable energy to be reduced and high carbon emissions.

In this embodiment, the CSP is introduced for combined energy supply, and an improved CHP unit model is established. By introducing the CSP unit for combined energy supply, the operation range of the CHP unit is expanded, and the electric energy output adjustment range thereof is effectively expanded, thereby providing more space for renewable energy consumption and effectively reducing carbon emissions.

The schematic diagram of a CHP operation range considering CSP-CHP combined energy supply is shown in FIG. 3.

Without considering combined energy supply with the CSP unit traditionally, the operation range of the CHP unit may be represented by the part contained in ABCD. When the heat storage part of the CSP unit outputs heat energy Qₒᵤₜ, the total heat energy output is increased by Qₒᵤₜ Therefore, after introducing the CSP unit to participate in combined energy supply, the operation range of the CHP unit becomes AA′B′C′CD. The results show that when the heat energy output is Q_{E}, the electric energy output adjustment range of the CHP unit is P_{E1}-P_{E2}. However, after introducing the CSP unit for combined energy supply, the electric energy output adjustment range is expanded to P_{E1′}-P_{E2′}. Therefore, by introducing the CSP unit for combined energy supply, the operation range of the CHP unit is expanded, and the electric energy output adjustment range thereof is effectively expanded, thereby providing more space for renewable energy consumption and effectively reducing carbon emissions.

For the improved CHP unit model established by introducing the CSP unit for combined energy supply:
(1) Constraint of heat power output

$${Q}_{n , min}^{c h p} \leq {Q}_{n , t}^{c h p} \leq {Q}_{n , max}^{c h p} \qquad ( 18 )$$

where Q_{n,t}^{chp} represents a heat power output of the CHP unit group n at t, Q_{n,min}^{chp} represents a minimum value of an output heat power of the CHP unit group n, and Q_{n,max}^{chp} represents a maximum value of the output heat power of the CHP unit group n.
(2) Constraint of electric power output

$${P}_{n , t}^{c h p} \geq max \{ {c}_{m , n} {Q}_{n , t}^{c h p} - ( {c}_{m , n} + {c}_{v , n} ) {Q}_{n , max}^{c h p} + {P}_{n , max}^{c h p} , {P}_{n , min}^{c h p} - {c}_{v , n} {Q}_{n , t}^{c h p} \} \qquad ( 19 )$$

$${P}_{n , t}^{c h p} \leq {P}_{n , max}^{c h p} - {c}_{v , n} {Q}_{n , t}^{c h p} \qquad ( 20 )$$

where p_{n,t}^{chp} represents an electric power output of the CHP unit group n at t, P_{n,min}^{chp} represents a minimum value of an output electric power of the CHP unit group n, P_{n,max}^{chp} represents a maximum value of the output electric power of the CHP unit group n, and c_{m,n} and c_{v,n} represent parameters of a feasible operation region of a CHP unit.
(3) Constraint of flexibility

$$( {P}_{n , t}^{c h p} + {c}_{v , n} {Q}_{n , t}^{c h p} ) - ( {P}_{n , t - 1}^{c h p} + {c}_{v , n} {Q}_{n , t - 1}^{c h p} ) \geq {\underline{A}}_{n , t}^{c h p} \cdot {S}_{chp , n , t}^{U} - {\underline{A}}_{n , t}^{chp} \cdot {S}_{chp , n , t}^{D} - {R}_{chp , n}^{D} ( {S}_{chp , n , t}^{O} - {S}_{chp , n , t}^{U} - {S}_{chp , n , t - 1}^{U} ) \qquad ( 21 )$$

$$( {P}_{n , t}^{c h p} + {c}_{v , n} {Q}_{n , t}^{c h p} ) - ( {P}_{n , t - 1}^{c h p} + {c}_{v , n} {Q}_{n , t - 1}^{c h p} ) \leq {\underline{A}}_{n , t}^{chp} \cdot {S}_{chp , n , t}^{U} - {\underline{A}}_{n , t}^{c h p} \cdot {S}_{chp , n , t}^{D} + {R}_{chp , n}^{U} ( {S}_{chp , n , t}^{O} - {S}_{chp , n , t}^{U} - {S}_{chp , n , t + 1}^{D} ) \qquad ( 22 )$$

$${P}_{n , t}^{chp} + {c}_{ν , n} {Q}_{n , t}^{chp} \leq {\overline{A}}_{n , t}^{chp} \cdot ( {S}_{chp , n , t}^{O} - {S}_{chp , n , t}^{U} - {S}_{chp , n , t + 1}^{D} ) + {\underline{A}}_{n , t}^{chp} \cdot {S}_{chp , n , t}^{U} + {\underline{A}}_{n , t}^{chp} \cdot {S}_{chp , n , t + 1}^{D} \qquad ( 23 )$$

$$0 \leq {S}_{chp , n , t}^{O} \leq {S}_{chp , n} \qquad ( 24 )$$

$${S}_{chp , n , t}^{O} - {S}_{chp , n , t - 1}^{O} = {S}_{chp , n , t}^{U} - {S}_{chp , n , t}^{D} \qquad ( 25 )$$

$${S}_{chp , n} = {\sum }_{i = 1}^{{I}^{′}} ( {P}_{i , max}^{chp} + {c}_{v , i} {Q}_{i , max}^{chp} ) \qquad ( 26 )$$

where p_{n,t}^{chp} represents the electric power output of the CHP unit group n at t, Q_{n,t}^{chp} represents the heat power output of the CHP unit group n at t, c_{v,n} represents the parameter of the feasible operation region of the CHP unit, P_{n,t-1}^{chp} represents an electric power output of the CHP unit group n at t−1, Q_{n,t-1}^{chp} represents a heat power output of the CHP unit group n at t−1, A_{n,t}^{chp} and Ā_{n,t}^{chp} respectively represent ratios of a minimum output power and a maximum output power of the CHP unit group n at t to a total online capacity of the CHP unit group n, S_{chp,n,t+1}^{O} represents the total online capacity of the CHP unit group n, R_{chp,n}^{U} and R_{chp,n}^{D} respectively represent a climb-up rate and a climb-down rate of the CHP unit group n, S_{chp,n,t}^{U} represents a total start capacity of the CHP unit group n, S_{chp,n,t}^{D} represents a total stop capacity of the CHP unit group n, S_{chp,n,t-1}^{U} represents a total start capacity of the CHP unit group n at t−1, S_{chp,n,t+1}^{D} represents a total stop capacity of the CHP unit group n at t+1, S_{chp,n,t-1}^{O} represents a total online capacity of the CHP unit group n at t−1, S_{chp,n}, represents a total capacity of the CHP unit group n, P_{i,max}^{chp} represents a maximum value of an output electric power of a CHP unit i in the CHP unit group n, Q_{i,max}^{chp} represents a maximum value of an output heat power of a CHP unit i in the CHP unit group n, and I′ represents the number of CHP units in the CHP unit group n.

The established high-proportion new energy system collaborative optimization model based on CSP-CHP combined energy supply includes:
(1) Objective function

The high-proportion new energy system collaborative optimization model based on CSP-CHP combined energy supply established in this embodiment has an objective of minimizing a total cost of high-proportion new energy system, the objective function includes a cost c_{coal} of a traditional coal-fired power generation unit, a cost C_{w} of the wind power generation unit, a cost Cₛ of the photovoltaic power generation unit, a cost C_{CSP} of the CSP unit, a cost C_{CHP} of the CHP unit, and a penalty cost C_{c} caused by abandoning wind and solar.

$$min C = {C}_{coal} + {C}_{w} + {C}_{s} + {C}_{CSP} + {C}_{CHP} + {C}_{c} \qquad ( 27 )$$

$${C}_{coal} = {\sum }_{m = 1}^{M} {a}_{coal , m} \cdot {I}_{coal , m} + {\sum }_{m = 1}^{M} {f}_{coal , m} \cdot {\overline{I}}_{coal , m} + {\sum }_{m = 1}^{M} {\sum }_{t = 1}^{T} {c}_{coal , m} \cdot {P}_{m , t}^{coal} \cdot Δ t + {\sum }_{m = 1}^{M} {\sum }_{t = 1}^{T} {st}_{coal , n} \cdot {S}_{coal , m , t}^{U} \qquad ( 28 )$$

$${C}_{w} = {a}_{w} \cdot {I}_{w} + {f}_{w} \cdot {\overline{I}}_{w} \qquad ( 29 )$$

$${C}_{s} = {a}_{s} \cdot {I}_{s} + {f}_{s} \cdot {\overline{I}}_{s} \qquad ( 30 )$$

$${C}_{CSP} = {\sum }_{j = 1}^{J} {a}_{csp , j} \cdot {I}_{chp , j} + {\sum }_{j = 1}^{J} {f}_{csp , j} \cdot {\overline{I}}_{csp , j} \qquad ( 31 )$$

$${C}_{CHP} = {\sum }_{n = 1}^{N} {a}_{chp , n} \cdot {I}_{chp , n} + {\sum }_{n = 1}^{N} {f}_{chp} \cdot {\overline{I}}_{chp , n} + {\sum }_{n = 1}^{N} {\sum }_{t = 1}^{T} {c}_{chp , n} \cdot ( {P}_{n , t}^{chp} + {c}_{v , n} {Q}_{n , t}^{chp} ) \cdot Δ t + {\sum }_{n = 1}^{N} {\sum }_{t = 1}^{T} {st}_{chp , n} \cdot {S}_{chp , n , t}^{U} \qquad ( 32 )$$

$${C}_{c} = {\sum }_{t = 1}^{T} {c}_{c} \cdot ( {P}_{t , max}^{w} - {P}_{t}^{w} ) + {\sum }_{t = 1}^{T} {c}_{c} \cdot ( {P}_{t , max}^{s} - {P}_{t}^{s} ) \qquad ( 33 )$$

where a_{coal,m}, f_{coal,m}, c_{coal,m}, and st_{coal,m}, respectively represent a new investment cost, a fixed operation and maintenance cost, a fuel cost, and a start-stop cost of the traditional coal-fired power generation unit, a_{w} and f_{w} respectively represent a new investment cost and a fixed operation and maintenance cost of the wind power generation unit, aₛ and fₛ respectively represent a new investment cost and a fixed operation and maintenance cost of the photovoltaic power generation unit, a_{csp,j}, and f_{csp,j} respectively represent a new investment cost and a fixed operation and maintenance cost of the CSP unit, a_{chp,n}, f_{chp,n}, c_{chp,n}, and st_{chp,n}, respectively represent a new investment cost, a fixed operation and maintenance cost, a fuel cost, and a start-stop cost of the CHP unit, C_{c}, represents a penalty cost coefficient caused by abandoning wind and solar, I_{coal,m}, Ī_{coal,m}, P_{m,t}^{coal}, and S_{coal,m,t}^{U} respectively represent a new capacity, a total capacity, an electric power output, and a start-stop capacity of the traditional coal-fired power generation unit, I_{w}, Ī_{w}, Pₜ^{w}, and P_{t,max}^{w} respectively represent a new capacity, a total capacity, an electric power output, and a maximum value of the electric power output of the wind power generation unit, Iₛ, Īs, Pₜ^{s}, and P_{t,max}^{s} respectively represent a new capacity, a total capacity, an electric power output, and a maximum value of the electric power output of the photovoltaic power generation unit, I_{csp,j} and Ī_{csp,j} respectively represent a new capacity and a total capacity of the CSP unit, I_{chp,j} and Ī_{chp,j} respectively represent a new capacity and a total capacity of the CHP unit, and M, j, and N respectively represent group numbers of the traditional coal-fired power generation unit, the CSP unit, and the CHP unit.
(2) Constraint condition
(2-1) Constraint of investment and operation decisions

$$0 \leq {P}_{m , t}^{coal} \leq {\overline{P}}_{m , t}^{c o a l} \leq {\overline{I}}_{c oal , m} = {I}_{c oal , m}^{0} + {I}_{c oal , m} \qquad ( 34 )$$

$$0 \leq {P}_{t}^{w} \leq {α}_{t} \cdot {\overline{I}}_{w} = {α}_{t} \cdot ( {I}_{w}^{0} + {I}_{w} ) \qquad ( 35 )$$

$$0 \leq {P}_{t}^{s} \leq {β}_{t} \cdot {\overline{I}}_{s} = {β}_{t} \cdot ( {I}_{s}^{0} + {I}_{s} ) \qquad ( 36 )$$

$$0 \leq {P}_{j , t}^{c s p} \leq {λ}_{t} \cdot {\overline{I}}_{csp , j} = {λ}_{t} \cdot ( {I}_{csp , j}^{0} + {I}_{csp , j} ) \qquad ( 37 )$$

$$0 \leq {P}_{n , t}^{chp} \leq {\overline{P}}_{n , t}^{chp} \leq {\overline{I}}_{chp , n} = {I}_{chp , n}^{0} + {I}_{chp , n} \qquad ( 38 )$$

where αₜ, βₜ, and λₜ respectively represent hourly capacity factors of the wind power generation unit, the photovoltaic power generation unit, and the CSP unit, P_{m,t}^{coal}, P̅_{m,t}^{coal}, Ī_{coal,m}, I_{coal,m}⁰, and I_{coal,m} respectively represent an electric power output, an online capacity, a total capacity, an existing capacity, and a new capacity of the traditional coal-fired power generation unit group m at t, Pₜ^{w}, Ī_{w}, Ī_{w}⁰, and I_{w} respectively represent an electric power output, a total capacity, an existing capacity, and a new capacity of the wind power generation unit at t, Pₜ^{s}, Īₛ, Īₛ⁰, and Iₛ, respectively represent an electric power output, a total capacity, an existing capacity, and a new capacity of the photovoltaic power generation unit at t, P_{j,t}^{csp}, Ī_{csp,j}, I_{csp,j}⁰, I_{csp,j} respectively represent an electric power output, a total capacity, an existing capacity, and a new capacity of the CSP unit group j at t, and P_{n,t}^{chp}, P̅_{n,t}^{chp}, Ī_{chp,n}, I_{chp,n}⁰, and I_{chp,n}, respectively represent an electric power output, an online capacity, a total capacity, an existing capacity, and a new capacity of the CHP unit group n at t.
(2-2) Constraint of system electric power balance

$${\sum }_{m = 1}^{M} {P}_{m , t}^{c o a l} + {P}_{t}^{w} + {P}_{t}^{s} + {\sum }_{j = 1}^{J} {P}_{j , t}^{csp} + {\sum }_{n = 1}^{N} {P}_{n , t}^{chp} = {D}_{E , t} \qquad ( 39 )$$

where D_{E,t} represents an electric load demand of an energy system at t.
(2-3) Constraint of system heat power balance

$${\sum }_{j = 1}^{J} {Q}_{j , t}^{TES , dis} + {\sum }_{n = 1}^{N} ( {Q}_{n , t}^{chp} - {Q}_{n , t}^{chp , cur} ) = {D}_{H , t} \qquad ( 40 )$$

where D_{H,t} represents a heat load demand of an energy system at t.
(2-4) System standby constraint

$${\sum }_{m = 1}^{M} {\overline{μ}}_{c oal , m} \cdot {\overline{P}}_{m , t}^{coal} + {α}_{t} \cdot {\overline{I}}_{w} + {β}_{t} \cdot {\overline{I}}_{s} + {λ}_{t} \cdot {\sum }_{j = 1}^{J} {\overline{I}}_{csp , j} + {\sum }_{n = 1}^{N} {\overline{μ}}_{chp , n} \cdot {\overline{P}}_{n , t}^{c h p} \geq {D}_{E , t} + {R}_{t}^{d} + {R}_{w} \cdot {P}_{t}^{w} + {R}_{s} \cdot {P}_{t}^{s} + {R}_{c} \cdot {\sum }_{j = 1}^{J} {P}_{j , t}^{c s p} \qquad ( 41 )$$

where M, j, and N respectively represent group numbers of the traditional coal-fired power generation unit, the CSP unit, and the CHP unit, μ̅_{coal,m} and μ̅_{chp,n} respectively represent maximum output ratios of the traditional coal-fired power generation unit group m and the CHP unit group n at t, P̅_{m,t}^{coal} represents the online capacity of the traditional coal-fired power generation unit group m at t, αₜ, βₜ, and λₜ respectively represent the hourly capacity factors of the wind power generation unit, the photovoltaic power generation unit, and the CSP unit, Ī_{w}, represents the total capacity of the wind power generation unit at t, Īₛ, represents the total capacity of the photovoltaic power generation unit at t, Ī_{csp,j} represents the total capacity of the CSP unit group j at t, P̅_{n,t}^{chp} represents the online capacity of the CHP unit group n at t, D_{E,t} represents the electric load demand of the energy system at t, Pₜ^{w} represents the electric power output of the wind power generation unit at t, Pₜ^{s} represents the electric power output of the photovoltaic power generation unit at t, and P_{j,t}^{csp} represents the electric power output of the CSP unit group j at t.

Rₜ^{d} represents a standby requirement related to the electric load demand at t, and R_{w}, Rₛ, and R_{C} respectively represent prediction errors of output powers of the wind power generation unit, the photovoltaic power generation unit, and the CSP unit.
(2-5) Constraint of low-carbon policy

$${P}_{t}^{w} + {P}_{t}^{s} + {\sum }_{j = 1}^{J} {P}_{j , t}^{csp} \geq r \cdot {D}_{E , t} \qquad ( 42 )$$

where r represents a proportion of a renewable energy power generation in a total power generation, Pₜ^{w} represents the electric power output of the wind power generation unit at t, Pₜ^{s} represents the electric power output of the photovoltaic power generation unit at t, P_{j,t}^{csp} represents the electric power output of the CSP unit group j at t, and D_{E,t} represents the electric load demand of the energy system at t.

In step 3, rated capacities of various units are acquired, and a capacity configuration and operation optimization scheme of various units in the high-proportion new energy system is obtained according to the rated capacities of various units and the established high-proportion new energy system collaborative optimization model based on CSP-CHP combined energy supply. Specifically,
relevant data is acquired, including rated capacity data of various units such as the traditional coal-fired power generation unit, the wind power generation unit, the photovoltaic power generation unit, the CSP unit, and the CHP unit, rated operating parameters of various units, including a power output limit and a climbing rate limit, investment costs, fixed operation and maintenance costs, fuel costs, and start-stop costs of various units, and wind and solar resource data of the planned region.

The acquired data is inputted into the constructed high-proportion new energy system planning and operation collaborative optimization model as shown in Formulas (1) to (42).

The model is solved using a GUROBI solver.

The data is outputted as new capacities and hourly electric power outputs of various units such as the traditional coal-fired power generation unit, the wind power generation unit, the photovoltaic power generation unit, the CSP unit, and the CHP unit, hourly heat power outputs of the CSP unit and the CHP unit, and a renewable energy reduction rate of the system.

### Embodiment 2

An object of this embodiment is to provide a computer device, including a memory, a processor, and computer programs stored on the memory and executable on the processor.

The processor, when executing the programs, implements the steps of the above-mentioned method.

### Embodiment 3

An object of this embodiment is to provide a computer-readable storage medium having computer programs stored thereon. The programs, when executed by a processor, implement the steps of the above-mentioned method.

### Embodiment 4

An object of this embodiment is to provide an apparatus for optimally configuring a capacity of a high-proportion new energy system. The apparatus is configured for: constructing, based on a CSP unit and a CHP unit, a high-proportion new energy system structure based on CSP-CHP combined energy supply;
establishing a CSP unit model and a CHP unit model based on the constructed high-proportion new energy system structure;
establishing, based on the CSP unit model and the CHP unit model, a high-proportion new energy system collaborative optimization model based on CSP-CHP combined energy supply; and
acquiring operating parameters of various units, cost data of various units, and wind and solar resource data of a planned region, inputting the acquired operating parameters of various units, cost data of various units, and wind and solar resource data of the planned region into the high-proportion new energy system collaborative optimization model based on CSP-CHP combined energy supply, and solving the high-proportion new energy system collaborative optimization model based on CSP-CHP combined energy supply to obtain capacity configurations of various units in the high-proportion new energy system.

The various steps and methods involved in the apparatus of Embodiments 2, 3, and 4 correspond to Embodiment 1. The specific implementations may be referred to the relevant description section of Embodiment 1. The term “computer-readable storage medium” should be understood as one or more media including one or more instruction sets, and should also be understood as any medium. The medium is capable of storing, encoding, or carrying the instruction sets for execution by the processor and causing the processor to perform any method of the present invention.

It will be appreciated by those skilled in the art that the modules or steps of the present invention may be implemented in a general purpose computer apparatus. Optionally, the modules or the steps may be implemented in a program code executable by a computing apparatus. Thus, the modules or the steps may be stored in a storage apparatus and executed by the computing apparatus. Alternatively, the modules or the steps may be separately fabricated into individual integrated circuit modules. Alternatively, multiple modules or steps thereof may be fabricated into a single integrated circuit module. The present invention is not limited to any particular combination of hardware and software.

Although the specific implementations of the present invention have been described in conjunction with the accompanying drawings, it is not a limitation of the scope of protection of the present invention. It will be appreciated by those skilled in the art that various modifications or modifications that may be made by those skilled in the art without creative labor are still within the scope of protection of the present invention on the basis of the technical solutions of the present invention.

1. A method for managing a capability of energy supply of a high-proportion new energy system, wherein the high-proportion new energy system comprises at least a concentrating solar power (CSP) unit and a combined heat and power (CHP) unit: the method comprising:
optimally configuring a capacity of the high-proportion new energy system, comprising:
constructing, based on CSP unit and the CHP unit, a structure of a high-proportion new energy system based on CSP-CHP combined energy supply;
establishing a CSP unit model and a CHP unit model based on the constructed structure of the high-proportion new energy system based on CSP-CHP combined energy supply;
establishing, based on the CSP unit model and the CHP unit model, a collaborative optimization model of the high-proportion new energy system based on CSP-CHP combined energy supply, wherein
the CSP unit model comprises:
(1) constraint of heat energy balance
$${Q}_{j , t}^{SF - HTF} + {Q}_{j , t}^{TES - HTF} = {Q}_{j , t}^{HTF - TES} + {Q}_{j , t}^{HTF - PB} \qquad ( 1 )$$
wherein Q_{j,t}^{SF-HTF} represents a heat power transferred to a heat transfer fluid from a solar concentrating and heat collecting part of a CSP unit group j at t, Q_{j,t}^{TES-HTF} represents a heat power transferred to the heat transfer fluid from a heat storage part of the CSP unit group j at t, Q_{j,t}^{HTF-TES} represents a heat power transferred to the heat storage part from the heat transfer fluid of the CSP unit group j at t, and Q_{j,t}^{HTF-PB} represents a heat power transferred to a power generation part from the heat transfer fluid of the CSP unit group j at t;
(2) constraint of solar concentrating and heat collecting link
$${Q}_{j , t}^{SF - HTF} = {η}_{S F} \cdot {S}_{S F} \cdot DNI - {Q}_{j , t}^{c u r} \qquad ( 2 )$$
wherein η_{SF} represents a solar-heat conversion efficiency factor of the solar concentrating and heat collecting part, S_{SF} represents an area of a mirror field in the solar concentrating and heat collecting part, DNI represents a solar direct normal radiation value, and Q_{j,t}^{cur} represents energy loss in the solar concentrating and heat collecting link of the CSP unit group j at t;
(3) constraint of heat storage link
$${Q}_{j , t}^{csp} = ( 1 - γ \cdot Δ t ) \cdot {Q}_{j , t - 1}^{csp} + ( {Q}_{j , t}^{TES , cha} - {Q}_{j , t}^{TES , dis} ) \cdot Δ t \qquad ( 3 )$$
$${Q}_{j , t}^{TES , cha} = {η}_{TES}^{cha} \cdot ( {Q}_{j , t}^{HTF - TES} + {Q}_{j , t}^{EH - TES} + {Q}_{n , t}^{chp , cur} ) \qquad ( 4 )$$
$${Q}_{j , t}^{TES , dis} = ( {Q}_{j , t}^{TES , HTF} + {Q}_{j , t}^{TES - HD} ) / {η}_{TES}^{dis} \qquad ( 5 )$$
$${Q}_{j , t}^{EH - TES} = {η}_{EH} \cdot ( {P}_{t}^{W - EH} + {P}_{t}^{S - EH} ) \qquad ( 6 )$$
$${Q}_{j , min}^{csp} \leq {Q}_{j , t}^{csp} \leq {Q}_{j , max}^{csp} \qquad ( 7 )$$
wherein Q_{j,t}^{csp} represents a state of charge of the heat storage part of the CSP unit group j at t, Q_{j,t}^{TES, cha} and Q_{j,t}^{TES,dis} respectively represent charged and discharged energy of the heat storage part at t, γ represents a heat dissipation rate, Δt represents a time interval, and Q_{j,t-1}^{csp} represents a state of charge of the heat storage part of the CSP unit group j at t−1;
Q_{j,t}^{HTF-TES} represents a heat power transferred to the heat storage part from the heat transfer fluid of the CSP unit group j at t, Q_{j,t}^{EH-TES} represents a heat power transferred to the heat storage part from an electric heating part of the CSP unit group j at t, and Q_{j,t}^{chp,cur} represents a heat power transferred to the heat storage part from a CHP unit group n at t;
Q_{j,t}^{TES-HTF} represents a heat power transferred to the heat transfer fluid from the heat storage part of the CSP unit group j at t, Q_{j,t}^{TES-HD} represents a heat power supplied to a heat load from the heat storage part of the CSP unit group j at t, and η_{TES}^{cha} and η_{TES}^{dis} respectively represent energy charging and discharging efficiency factors of the heat storage part;
η_{EH} represents an efficiency factor of the electric heating part, and pₜ^{W-EH} and pₜ^{S-EH} respectively represent electric powers inputted to the electric heating part from a wind power generation unit and a photovoltaic power generation unit; and
Q_{j,min}^{csp} and Q_{j,max}^{csp} respectively represent a minimum value and a maximum value of the state of charge of the heat storage part of the CSP unit group j;
(4) constraint of power generation link
$${Q}_{j , t}^{HTF - PB} = {P}_{j , t}^{c s p} / {η}_{P B} \qquad ( 8 )$$
wherein η_{PB} represents an efficiency factor of the power generation part, Q_{j,t}^{HTF-PB} represents a heat power transferred from the heat transfer fluid of the CSP unit group j to the power generation part at t, and P_{j,t}^{csp} represents an electric power output of the CSP unit group j at t;
(5) constraint of flexibility
$${P}_{j , min}^{csp} \leq {P}_{j , t}^{csp} \leq {P}_{j , max}^{csp} \qquad ( 9 )$$
$${P}_{j , min}^{csp} = {\underline{A}}_{j , t}^{csp} \cdot {S}_{csp , j , t}^{O} \qquad ( 10 )$$
$${P}_{j , max}^{csp} = {\overline{A}}_{j , t}^{csp} \cdot {S}_{csp , j , t}^{O} \qquad ( 11 )$$
$${P}_{j , t}^{c s p} - {P}_{j , t - 1}^{c s p} \geq {\underline{A}}_{j , t}^{c s p} \cdot {S}_{csp , j , t}^{U} - {\underline{A}}_{j , t}^{c s p} \cdot {S}_{csp , j , t}^{D} - {R}_{csp , j , t}^{D} ( {S}_{csp , j , t}^{O} - {S}_{csp , j , t}^{U} - {S}_{csp , j , t - 1}^{U} ) \qquad ( 12 )$$
$${P}_{j , t}^{c s p} - {P}_{j , t - 1}^{c s p} \leq {\underline{A}}_{j , t}^{c s p} \cdot {S}_{csp , j , t}^{U} - {\underline{A}}_{j , t}^{c s p} \cdot {S}_{csp , j , t}^{D} + {R}_{csp , j}^{U} ( {S}_{csp , j , t}^{O} - {S}_{csp , j , t}^{U} - {S}_{csp , j , t + 1}^{D} ) \qquad ( 13 )$$
$${P}_{j , t}^{csp} \leq {\overline{A}}_{j , t}^{csp} \cdot ( {S}_{csp , j , t}^{O} - {S}_{csp , j , t}^{U} - {S}_{csp , j , t + 1}^{D} ) + {\underline{A}}_{j , t}^{csp} \cdot {S}_{csp , j , t}^{U} + {\underline{A}}_{j , t}^{csp} \cdot {S}_{csp , j , t + 1}^{D} \qquad ( 14 )$$
$$0 \leq {S}_{csp , j , t}^{O} \leq {S}_{csp , j} \qquad ( 15 )$$
$${S}_{csp , j , t}^{O} - {S}_{csp , j , t - 1}^{O} = {S}_{csp , j , t}^{U} - {S}_{csp , j , t}^{D} \qquad ( 16 )$$
$${S}_{csp , j} = {\sum }_{i = 1}^{I} {P}_{i , max}^{c s p} \qquad ( 17 )$$
wherein P_{j,t}^{csp} represents the electric power output of the CSP unit group j at t, P_{j,min}^{csp} represents a minimum value of an output electric power of the CSP unit group j, and P_{j,max}^{csp} represents a maximum value of the output electric power of the CSP unit group j;
A_{j,t}^{csp} and Ā_{j,t}^{csp} respectively represent ratios of a minimum output electric power and a maximum output electric power of the CSP unit group j to a total online capacity of the CSP unit group j, and S_{csp,j,t}^{O} represents a total online capacity of the CSP unit group j at t;
P_{j,t-1}^{csp} represents an electric power output of the CSP unit group j at t−1, S_{csp,j,t}^{U} represents a total start capacity of the CSP unit group j at t, S_{csp,j,t}^{D} represents a total stop capacity of the CSP unit group j at t, R_{csp,j}^{U} and R_{csp,j}^{D} respectively represent a climb-up rate and a climb-down rate of the CSP unit group j, S_{csp,j,t-1}^{U} represents a total start capacity of the CSP unit group j at t−1, and S_{csp,j,t+1} represents a total stop capacity of the CSP unit group j at t+1; and
S_{csp,j,t-1}^{O} represents a total online capacity of the CSP unit group j at t−1, S_{csp,j} represents a total capacity of the CSP unit group j, and P_{i,max}^{csp} represents a maximum value of an output electric power of a CSP unit i in the CSP unit group j, and I represents the number of CSP units in the CSP unit group j;
the CHP unit model comprises:
(1) constraint of heat power output
$${Q}_{n , min}^{chp} \leq {Q}_{n , t}^{chp} \leq {Q}_{n , max}^{chp} \qquad ( 18 )$$
wherein Q_{n,t}^{chp} represents a heat power output of the CHP unit group n at t, Q_{n,min}^{chp} represents a minimum value of an output heat power of the CHP unit group n, and Q_{n,max}^{chp} represents a maximum value of the output heat power of the CHP unit group n;
(2) constraint of electric power output
$${P}_{n , t}^{c h p} \geq max \{ {c}_{m , n} {Q}_{n , t}^{c h p} - ( {c}_{m , n} + {c}_{v , n} ) {Q}_{n , max}^{c h p} + {P}_{n , max}^{c h p} , {P}_{n , min}^{c h p} - {c}_{v , n} {Q}_{n , t}^{c h p} \} \qquad ( 19 )$$
$${P}_{n , t}^{c h p} \leq {P}_{n , max}^{c h p} - {c}_{v , n} {Q}_{n , t}^{c h p} \qquad ( 20 )$$
wherein P_{n,t}^{chp} represents an electric power output of the CHP unit group n at t, p_{n,min}^{chp} represents a minimum value of an output electric power of the CHP unit group n, P_{n,max}^{chp} represents a maximum value of the output electric power of the CHP unit group n, and c_{m,n} and c_{v,n} represent parameters of a feasible operation region of a CHP unit;
(3) constraint of flexibility
$$( {P}_{n , t}^{c h p} + {c}_{v , n} {Q}_{n , t}^{c h p} ) - ( {P}_{n , t - 1}^{chp} + {c}_{v , n} {Q}_{n , t - 1}^{c h p} ) \geq {\underline{A}}_{n , t}^{chp} \cdot {S}_{chp , n , t}^{U} - {\underline{A}}_{n , t}^{chp} \cdot {S}_{chp , n , t}^{D} - {R}_{chp , n}^{D} ( {S}_{chp , n , t}^{O} - {S}_{chp , n , t}^{U} - {S}_{chp , n , t - 1}^{U} ) \qquad ( 21 )$$
$$( {P}_{n , t}^{c h p} + {c}_{v , n} {Q}_{n , t}^{c h p} ) - ( {P}_{n , t - 1}^{chp} + {c}_{v , n} {Q}_{n , t - 1}^{c h p} ) \leq {\underline{A}}_{n , t}^{chp} \cdot {S}_{chp , n , t}^{U} - {\underline{A}}_{n , t}^{chp} \cdot {S}_{chp , n , t}^{D} + {R}_{chp , n}^{U} ( {S}_{chp , n , t}^{O} - {S}_{chp , n , t}^{U} - {S}_{chp , n , t + 1}^{D} ) \qquad ( 22 )$$
$${P}_{n , t}^{c h p} + {c}_{v , n} {Q}_{n , t}^{c h p} \leq {\overline{A}}_{n , t}^{chp} \cdot ( {S}_{chp , n , t}^{O} - {S}_{chp , n , t}^{U} - {S}_{chp , n , t + 1}^{D} ) + {\underline{A}}_{n , t}^{chp} \cdot {S}_{chp , n , t}^{U} - {\underline{A}}_{n , t}^{chp} \cdot {S}_{chp , n , t + 1}^{D} \qquad ( 23 )$$
$$0 \leq {S}_{chp , n , t}^{O} \leq {S}_{chp , n} \qquad ( 24 )$$
$${S}_{chp , n , t}^{O} - {S}_{chp , n , t - 1}^{O} = {S}_{chp , n , t}^{U} - {S}_{chp , n , t}^{D} \qquad ( 25 )$$
$${S}_{chp , n} = {\sum }_{i = 1}^{{I}^{′}} ( {P}_{i , max}^{chp} + {c}_{v , i} {Q}_{i , max}^{c h p} ) \qquad ( 26 )$$
wherein p_{n,t}^{chp} represents the electric power output of the CHP unit group n at t, Q_{n,t}^{chp} represents the heat power output of the CHP unit group n at t, c_{v,n} represents the parameter of the feasible operation region of the CHP unit, P_{n,t-1}^{chp} represents an electric power output of the CHP unit group n at t−1, Q_{n,t-1}^{chp} represents a heat power output of the CHP unit group n at t−1, A_{n,t}^{chp} and Ā_{n,t}^{chp} respectively represent ratios of a minimum output power and a maximum output power of the CHP unit group n at t to a total online capacity of the CHP unit group n, S_{chp,n,t}^{O} represents the total online capacity of the CHP unit group n, R_{chp,n}^{U}, and R_{chp,n}^{D} respectively represent a climb-up rate and a climb-down rate of the CHP unit group n, S_{chp,n,t}^{U} represents a total start capacity of the CHP unit group n, S_{chp,n,t}^{D} represents a total stop capacity of the CHP unit group n, S_{chp,n,t-1}^{U} represents a total start capacity of the CHP unit group n at t−1, S_{chp,n,t+1}^{D} represents a total stop capacity of the CHP unit group n at t+1, S_{chp,n,t-1}^{O} represents a total online capacity of the CHP unit group n at t−1, S_{chp,n,t-1} represents a total capacity of the CHP unit group n, P_{i,max}^{chp} represents a maximum value of an output electric power of a CHP unit i in the CHP unit group n, Q_{i,max}^{chp} represents a maximum value of an output heat power of a CHP unit i in the CHP unit group n, and I′ represents the number of CHP units in the CHP unit group n;
the collaborative optimization model of the high-proportion new energy system based on CSP-CHP combined energy supply comprises:
(1) objective function
the established high-proportion new energy system collaborative optimization model based on CSP-CHP combined energy supply has an objective of minimizing a total system cost of high-proportion renewable energy consumption, the objective function comprises a cost C_{coal} of a traditional coal-fired power generation unit, a cost C_{w} of the wind power generation unit, a cost Cₛ of the photovoltaic power generation unit, a cost C_{CSP} of the CSP unit, a cost C_{CHP} of the CHP unit, and a penalty cost C_{c} caused by abandoning wind and solar;
$$min C = {C}_{coal} + {C}_{w} + {C}_{s} + {C}_{CSP} + {C}_{CHP} + {C}_{c} \qquad ( 27 )$$
$${C}_{coal} = {\sum }_{m = 1}^{M} {a}_{coal , m} \cdot {I}_{coal , m} + {\sum }_{m = 1}^{M} {f}_{coal , m} \cdot {\overline{I}}_{coal , m} + {\sum }_{m = 1}^{M} {\sum }_{t = 1}^{T} {c}_{coal , m} \cdot {P}_{m , t}^{coal} \cdot Δ t + {\sum }_{m = 1}^{M} {\sum }_{t = 1}^{T} {st}_{coal , m} \cdot {S}_{coal , m , t}^{U} \qquad ( 28 )$$
$${C}_{w} = {a}_{w} \cdot {I}_{w} + {f}_{w} \cdot {\overline{I}}_{w} \qquad ( 29 )$$
$${C}_{s} = {a}_{s} \cdot {I}_{s} + {f}_{s} \cdot {\overline{I}}_{s} \qquad ( 30 )$$
$${C}_{CSP} = {\sum }_{j = 1}^{J} {a}_{csp , j} \cdot {I}_{csp , j} + {\sum }_{j = 1}^{J} {f}_{csp , j} \cdot {\overline{I}}_{csp , j} \qquad ( 31 )$$
$${C}_{CHP} = {\sum }_{n = 1}^{N} {a}_{chp , j} \cdot {I}_{chp , j} + {\sum }_{n = 1}^{N} {f}_{chp , n} \cdot {\overline{I}}_{chp , n} + {\sum }_{n = 1}^{N} {\sum }_{t = 1}^{T} {c}_{chp , n} \cdot ( {P}_{n , t}^{c h p} + {c}_{v , n} {Q}_{n , t}^{c h p} ) \cdot Δ t {\sum }_{n = 1}^{N} {\sum }_{t = 1}^{T} {st}_{chp , n} \cdot {S}_{chp , n , t}^{U} \qquad ( 32 )$$
$${C}_{c} = {\sum }_{t = 1}^{T} {c}_{c} \cdot ( {P}_{t , max}^{w} - {P}_{t}^{w} ) + {\sum }_{t = 1}^{T} {c}_{c} \cdot ( {P}_{t , max}^{s} - {P}_{t}^{s} ) \qquad ( 33 )$$
wherein a_{coal,m}, f_{coal,m}, c_{coal,m}, and st_{coal,m}, respectively represent a new investment cost, a fixed operation and maintenance cost, a fuel cost, and a start-stop cost of the traditional coal-fired power generation unit, a_{w} and f_{w} respectively represent a new investment cost and a fixed operation and maintenance cost of the wind power generation unit, aₛ and fₛ respectively represent a new investment cost and a fixed operation and maintenance cost of the photovoltaic power generation unit, a_{csp,j} and f_{csp,j} respectively represent a new investment cost and a fixed operation and maintenance cost of the CSP unit, a_{chp,n}, f_{chp,n}, c_{chp,n}, and st_{chp,n} respectively represent a new investment cost, a fixed operation and maintenance cost, a fuel cost, and a start-stop cost of the CHP unit, c_{c} represents a penalty cost coefficient caused by abandoning wind and solar, I_{coal,m}, Ī_{coal,m}, P_{m,t}^{coal}, and S_{coal,m,t}^{U} respectively represent a new capacity, a total capacity, an electric power output, and a start-stop capacity of the traditional coal-fired power generation unit, I_{w}, Ī̅_{w}, Pₜ^{w}, and P_{t,max}^{w} respectively represent a new capacity, a total capacity, an electric power output, and a maximum value of the electric power output of the wind power generation unit, Iₛ, Īₛ, Pₜ^{s}, and P_{t,max}^{s} respectively represent a new capacity, a total capacity, an electric power output, and a maximum value of the electric power output of the photovoltaic power generation unit, I_{csp,j}, and Ī_{csp,j} respectively represent a new capacity and a total capacity of the CSP unit, I_{chp,j} and Ī_{chp,j} respectively represent a new capacity and a total capacity of the CHP unit, and M, J, and N respectively represent group numbers of the traditional coal-fired power generation unit, the CSP unit, and the CHP unit;
(2) constraint condition
(2-1) constraint of investment and operation decisions
$$0 \leq {P}_{m , t}^{coal} \leq {\overline{P}}_{m , t}^{coal} \leq {\overline{I}}_{c oal , m} = {I}_{c oal , m}^{0} + {I}_{c oal , m} \qquad ( 34 )$$
$$0 \leq {P}_{t}^{w} \leq {α}_{t} \cdot {\overline{I}}_{w} = {α}_{t} \cdot ( {I}_{w}^{0} + {I}_{w} ) \qquad ( 35 )$$
$$0 \leq {P}_{t}^{s} \leq {β}_{t} \cdot {\overline{I}}_{s} = {β}_{t} \cdot ( {I}_{s}^{0} + {I}_{s} ) \qquad ( 36 )$$
$$0 \leq {P}_{j , t}^{c s p} \leq {λ}_{t} \cdot {\overline{I}}_{csp , j} = {λ}_{t} \cdot ( {I}_{csp , j}^{0} + {I}_{csp , j} ) \qquad ( 37 )$$
$$0 \leq {P}_{n , t}^{c h p} \leq {\overline{P}}_{n , t}^{c h p} \leq {\overline{I}}_{chp , n} = {I}_{chp , n}^{0} + {I}_{chp , n} \qquad ( 38 )$$
wherein αₜ, βₜ, and λₜ respectively represent hourly capacity factors of the wind power generation unit, the photovoltaic power generation unit, and the CSP unit, P_{m,t}^{coal}, P̅_{m,t}^{coal}, Ī_{coal,m}, I_{coal,m}⁰, and I_{coal,m} respectively represent an electric power output, an online capacity, a total capacity, an existing capacity, and a new capacity of the traditional coal-fired power generation unit group m at t, Pₜ^{w}, Ī_{w}, Ī_{w}⁰, and I_{w} respectively represent an electric power output, a total capacity, an existing capacity, and a new capacity of the wind power generation unit at t, Pₜ^{s}, Iₛ⁰, and Iₛ, respectively represent an electric power output, a total capacity, an existing capacity, and a new capacity of the photovoltaic power generation unit at t, P_{j,t}^{csp}, Ī_{csp,j}, I_{csp,j}⁰, and I_{csp,j} respectively represent an electric power output, a total capacity, an existing capacity, and a new capacity of the CSP unit group j at t, and P_{n,t}^{chp}, P̅_{n,t}^{chp}, Ī_{chp,n}, I_{chp,n}⁰, and I_{chp,n}, respectively represent an electric power output, an online capacity, a total capacity, an existing capacity, and a new capacity of the CHP unit group n at t;
(2-2) constraint of system electric power balance
$${\sum }_{m = 1}^{M} {P}_{m , t}^{c o a l} + {P}_{t}^{w} + {P}_{t}^{s} + {\sum }_{j = 1}^{J} {P}_{j , t}^{csp} + {\sum }_{n = 1}^{N} {P}_{n , t}^{chp} = {D}_{E , t} \qquad ( 39 )$$
wherein D_{E,t} represents an electric load demand of an energy system at t;
(2-3) constraint of system heat power balance
$${\sum }_{j = 1}^{J} {Q}_{j , t}^{TES , dis} + {\sum }_{n = 1}^{N} ( {Q}_{n , t}^{chp} - {Q}_{n , t}^{chp , cur} ) = {D}_{H , t} \qquad ( 40 )$$
wherein D_{H,t} represents a heat load demand of an energy system at t;
(2-4) system standby constraint
$${\sum }_{m = 1}^{M} {\overline{μ}}_{c oal , m} \cdot {\overline{P}}_{m , t}^{c o a l} + {α}_{t} \cdot {\overline{I}}_{w} + {β}_{t} \cdot {\overline{I}}_{s} + {λ}_{t} \cdot {\sum }_{j = 1}^{J} {\overline{I}}_{csp , j} + {\sum }_{n = 1}^{N} {\overline{μ}}_{chp , n} \cdot {\overline{P}}_{n , t}^{c h p} \geq {D}_{E , t} + {R}_{t}^{d} + {R}_{w} \cdot {P}_{t}^{w} + {R}_{s} \cdot {P}_{t}^{s} + {R}_{c} \cdot {\sum }_{j = 1}^{J} {P}_{j , t}^{c s p} \qquad ( 41 )$$
wherein M, J, and N respectively represent group numbers of the traditional coal-fired power generation unit, the CSP unit, and the CHP unit, μ̅_{coal,m} and μ̅_{chp,n} respectively represent maximum output ratios of the traditional coal-fired power generation unit group m and the CHP unit group n at t, P̅_{m,t}^{coal} represents the online capacity of the traditional coal-fired power generation unit group m at t, αₜ, βₜ, and λₜ, respectively represent the hourly capacity factors of the wind power generation unit, the photovoltaic power generation unit, and the CSP unit, Ī_{w}, represents the total capacity of the wind power generation unit at t, Īₛ, represents the total capacity of the photovoltaic power generation unit at t, Ī_{csp,j} represents the total capacity of the CSP unit group j at t, P̅_{n,t}^{chp} represents the online capacity of the CHP unit group n at t, D_{E,t} represents the electric load demand of the energy system at t, Pₜ^{w} represents the electric power output of the wind power generation unit at t, Pₜ^{s} represents the electric power output of the photovoltaic power generation unit at t, and P_{j,t}^{csp} represents the electric power output of the CSP unit group j at t;
Rₜ^{d} represents a standby requirement related to the electric load demand at t, and R_{w}, Rₛ, and R_{c} respectively represent prediction errors of output powers of the wind power generation unit, the photovoltaic power generation unit, and the CSP unit;
(2-5) constraint of low-carbon policy
$${P}_{t}^{w} + {P}_{t}^{s} + {\sum }_{j = 1}^{J} {P}_{j , t}^{csp} \geq r \cdot {D}_{E , t} \qquad ( 42 )$$
wherein r represents a proportion of a renewable energy power generation in a total power generation, Pₜ^{w} represents the electric power output of the wind power generation unit at t, Pₜ^{s} represents the electric power output of the photovoltaic power generation unit at t, P_{j,t}^{csp}, represents the electric power output of the CSP unit group j at t, and D_{E,t} represents the electric load demand of the energy system at t; and
acquiring operating parameters of various units, cost data of various units, and wind and solar resource data of a planned region, inputting the acquired operating parameters of various units, cost data of various units, and wind and solar resource data of the planned region into the collaborative optimization model of the high-proportion new energy system based on CSP-CHP combined energy supply, and solving the collaborative optimization model of the high-proportion new energy system based on CSP-CHP combined energy supply to obtain optimized capacity configurations of various units in the high-proportion new energy system; and
adjusting capacities of the various units in the high-proportion new energy system if the capacities do not match the obtained optimized capacity configurations, to maintain the capability of energy supply of the high-proportion new energy system, so as to improve an operation flexibility and safety of the high-proportion new energy system during a heating period.

2. The method for managing the capability of energy supply of the high-proportion new energy system according to claim 1, wherein the CSP unit comprises the solar concentrating and heat collecting part, the heat storage part, and the power generation part.

3. The method for managing the capability of energy supply of the high-proportion new energy system according to claim 1, wherein the obtained optimized capacity configurations of the various units comprise: new capacities and hourly electric power outputs of the coal-fired power generation unit, the wind power generation unit, the photovoltaic power generation unit, the CSP unit, and the CHP unit, hourly heat power outputs of the CSP unit and the CHP unit, and a renewable energy reduction rate of the system.

4. The method for managing the capability of energy supply of the high-proportion new energy system according to claim 1, wherein the collaborative optimization model of the high-proportion new energy system based on CSP-CHP combined energy supply is solved by using a GUROBI solver.

5-13. (canceled)

14. A computer equipment, comprising:
at least one processor;
at least one memory that is non-transitory, the at least one memory storing computer executable programs, wherein the at least one memory and the computer executable programs are executable by the at least one processor, to cause the apparatus to:
construct, based on a CSP unit and a CHP unit, a structure of a high-proportion new energy system based on CSP-CHP combined energy supply;
establish a CSP unit model and a CHP unit model based on the constructed structure of the high-proportion new energy system based on CSP-CHP combined energy supply;
establish, based on the CSP unit model and the CHP unit model, a collaborative optimization model of the high-proportion new energy system based on CSP-CHP combined energy supply; wherein,
the CSP unit model comprises:
(1) constraint of heat energy balance
$${Q}_{j , t}^{SF - HTF} + {Q}_{j , t}^{TES - HTF} = {Q}_{j , t}^{HTF - TES} + {Q}_{j , t}^{HTF - PB} \qquad ( 1 )$$
wherein, Q_{j,t}^{SF-HTF} represents a heat power transferred to a heat transfer fluid from a solar concentrating and heat collecting part of a CSP unit group j at t, Q_{j,t}^{TES-HTF} represents a heat power transferred to the heat transfer fluid from a heat storage part of the CSP unit group j at t, Q_{j,t}^{HTF-TES} represents a heat power transferred to the heat storage part from the heat transfer fluid of the CSP unit group j at t, and Q_{j,t}^{HTF-PB} represents a heat power transferred to a power generation part from the heat transfer fluid of the CSP unit group j at t;
(2) constraint of solar concentrating and heat collecting link
$${Q}_{j , t}^{SF - HTF} = {η}_{SF} \cdot {S}_{SF} \cdot DNI - {Q}_{j , t}^{cur} \qquad ( 2 )$$
wherein η_{SF} represents a solar-heat conversion efficiency factor of the solar concentrating and heat collecting part, S_{SF} represents an area of a mirror field in the solar concentrating and heat collecting part, DNI represents a solar direct normal radiation value, and Q_{j,t}^{cur} represents energy loss in the solar concentrating and heat collecting link of the CSP unit group j at t;
(3) constraint of heat storage link
$${Q}_{j , t}^{csp} = ( 1 - γ \cdot Δ t ) \cdot {Q}_{j , t - 1}^{csp} + ( {Q}_{j , t}^{TES , cha} - {Q}_{j , t}^{TES , dis} ) \cdot Δ t \qquad ( 3 )$$
$${Q}_{j , t}^{TES , cha} = {η}_{TES}^{cha} \cdot ( {Q}_{j , t}^{HTF - TES} + {Q}_{j , t}^{EH - TES} + {Q}_{n , t}^{chp , cur} ) \qquad ( 4 )$$
$${Q}_{j , t}^{TES , dis} = ( {Q}_{j , t}^{TES - HTF} + {Q}_{j , t}^{TES - HD} ) / {η}_{TES}^{dis} \qquad ( 5 )$$
$${Q}_{j , t}^{EH - TES} = {η}_{EH} \cdot ( {P}_{t}^{W - EH} + {P}_{t}^{S - EH} ) \qquad ( 6 )$$
$${Q}_{j , min}^{csp} \leq {Q}_{j , t}^{csp} \leq {Q}_{j , max}^{csp} \qquad ( 7 )$$
wherein Q_{j,t}^{csp} represents a state of charge of the heat storage part of the CSP unit group j at t, Q_{j,t}^{TES,cha} and Q_{j,t}^{TES,dis} respectively represent charged and discharged energy of the heat storage part at t, γ represents a heat dissipation rate, Δt represents a time interval, and Q_{j,t-1}^{csp} represents a state of charge of the heat storage part of the CSP unit group j at t−1;
Q_{j,t}^{HTF-TES} represents a heat power transferred to the heat storage part from the heat transfer fluid of the CSP unit group j at t, Q_{j,t}^{EH-TES} represents a heat power transferred to the heat storage part from an electric heating part of the CSP unit group j at t, and Q_{n,t}^{chp,cur} represents a heat power transferred to the heat storage part from a CHP unit group n at t;
Q_{j,t}^{TES-HTF} represents a heat power transferred to the heat transfer fluid from the heat storage part of the CSP unit group j at t, Q_{j,t}^{TES-HD} represents a heat power supplied to a heat load from the heat storage part of the CSP unit group j at t, and η_{TES}^{cha} and η_{TES}^{dis} respectively represent energy charging and discharging efficiency factors of the heat storage part;
η_{EH} represents an efficiency factor of the electric heating part, and Pₜ^{W-EH} and Pₜ^{S-EH} respectively represent electric powers inputted to the electric heating part from a wind power generation unit and a photovoltaic power generation unit; and
Q_{j,min}^{csp} and Q_{j,max}^{csp} respectively represent a minimum value and a maximum value of the state of charge of the heat storage part of the CSP unit group j;
(4) constraint of power generation link
$${Q}_{j , t}^{HTF - PB} = {P}_{j , t}^{csp} / {η}_{PB} \qquad ( 8 )$$
wherein η_{PB} represents an efficiency factor of the power generation part, Q_{j,t}^{HTF-PB} represents a heat power transferred from the heat transfer fluid of the CSP unit group j to the power generation part at t, and P_{j,t}^{csp} represents an electric power output of the CSP unit group j at t;
(5) constraint of flexibility
$${P}_{j , min}^{csp} \leq {P}_{j , t}^{csp} \leq {P}_{j , max}^{csp} \qquad ( 9 )$$
$${P}_{j , min}^{csp} = {\underline{A}}_{j , t}^{csp} \cdot {S}_{csp , j , t}^{O} \qquad ( 10 )$$
$${P}_{j , max}^{csp} = {\overline{A}}_{j , t}^{csp} \cdot {S}_{csp , j , t}^{O} \qquad ( 11 )$$
$${P}_{j , t}^{csp} - {P}_{j , t - 1}^{csp} \geq {\underline{A}}_{j , t}^{csp} \cdot {S}_{csp , j , t}^{U} - {\underline{A}}_{j , t}^{csp} \cdot {S}_{csp , j , t}^{D} - {R}_{csp , j}^{D} ( {S}_{csp , j , t}^{O} - {S}_{csp , j , t}^{U} - {S}_{csp , j , t - 1}^{U} ) \qquad ( 12 )$$
$${P}_{j , t}^{csp} - {P}_{j , t - 1}^{csp} \leq {\underline{A}}_{j , t}^{csp} \cdot {S}_{csp , j , t}^{U} - {\underline{A}}_{j , t}^{csp} \cdot {S}_{csp , j , t}^{D} + {R}_{csp , j}^{U} ( {S}_{csp , j , t}^{O} - {S}_{csp , j , t}^{U} - {S}_{csp , j , t + 1}^{U} ) \qquad ( 13 )$$
$${P}_{j , t}^{csp} \leq {\overline{A}}_{j , t}^{csp} \cdot ( {S}_{csp , j , t}^{O} - {S}_{csp , j , t}^{U} - {S}_{csp , j , t + 1}^{D} ) + {\underline{A}}_{j , t}^{csp} \cdot {S}_{csp , j , t}^{U} + {\underline{A}}_{j , t}^{csp} \cdot {S}_{csp , j , t + 1}^{D} \qquad ( 14 )$$
$$0 \leq {S}_{csp , j , t}^{O} \leq {S}_{csp , j} \qquad ( 15 )$$
$${S}_{csp , j , t}^{O} - {S}_{csp , j , t - 1}^{O} = {S}_{csp , j , t}^{U} - {S}_{csp , j , t}^{D} \qquad ( 16 )$$
$${S}_{csp , j} = {\sum }_{i = 1}^{I} {P}_{i , max}^{csp} \qquad ( 17 )$$
wherein P_{j,t}^{csp} represents the electric power output of the CSP unit group j at t, P_{j,min}^{csp} represents a minimum value of an output electric power of the CSP unit group j, and P_{j,max}^{csp} represents a maximum value of the output electric power of the CSP unit group j;
A_{j,t}^{csp} and Ā_{j,t}^{csp} respectively represent ratios of a minimum output electric power and a maximum output electric power of the CSP unit group j to a total online capacity of the CSP unit group j, and S_{csp,j,t}^{O} represents a total online capacity of the CSP unit group j at t;
P_{j,t-1}^{csp} represents an electric power output of the CSP unit group j at t−1, S_{csp,j,t}^{U} represents a total start capacity of the CSP unit group j at t, S_{csp,j,t}^{D} represents a total stop capacity of the CSP unit group j at t, R_{csp,j}^{U} and R_{csp,j}^{D} respectively represent a climb-up rate and a climb-down rate of the CSP unit group j, S_{csp,j,t-1}^{U} represents a total start capacity of the CSP unit group j at t−1, and S_{csp,j,t+1}^{D} represents a total stop capacity of the CSP unit group j at t+1; and
S_{csp,j,t-1}^{O} represents a total online capacity of the CSP unit group j at t−1, S_{csp,j} represents a total capacity of the CSP unit group j, and P_{i,max}^{csp} represents a maximum value of an output electric power of a CSP unit i in the CSP unit group j, and I represents the number of CSP units in the CSP unit group j;
the CHP unit model comprises:
(1) constraint of heat power output
$${Q}_{n , min}^{chp} \leq {Q}_{n , t}^{chp} \leq {Q}_{n , max}^{chp} \qquad ( 18 )$$
wherein Q_{n,t}^{chp} represents a heat power output of the CHP unit group n at t, Q_{n,min}^{chp} represents a minimum value of an output heat power of the CHP unit group n, and Q_{n,max}^{chp} represents a maximum value of the output heat power of the CHP unit group n;
(2) constraint of electric power output
$${P}_{n , t}^{chp} \geq max \{ {c}_{m , n} {Q}_{n , t}^{chp} - ( {c}_{m , n} + {c}_{v , n} ) {Q}_{n , max}^{chp} + {P}_{n , max}^{chp} , {P}_{n , min}^{chp} - {c}_{v , n} {Q}_{n , t}^{chp} \} \qquad ( 19 )$$
$${P}_{n , t}^{chp} \leq {P}_{n , max}^{chp} - {c}_{v , n} {Q}_{n , t}^{chp} \qquad ( 20 )$$
wherein P_{n,t}^{chp} represents an electric power output of the CHP unit group n at t, P_{n,min}^{chp} represents a minimum value of an output electric power of the CHP unit group n, P_{n,max}^{chp} represents a maximum value of the output electric power of the CHP unit group n, and c_{m,n} and C_{v,n} represent parameters of a feasible operation region of a CHP unit;
(3) constraint of flexibility
$$( {P}_{n , t}^{chp} + {c}_{v , n} {Q}_{n , t}^{chp} ) - ( {P}_{n , t - 1}^{chp} + {c}_{v , n} {Q}_{n , t - 1}^{chp} ) \geq {\underline{A}}_{n , t}^{chp} \cdot {S}_{chp , n , t}^{U} - {\underline{A}}_{n , t}^{chp} \cdot {S}_{chp , n , t}^{D} - {R}_{chp , n}^{D} ( {S}_{chp , n , t}^{O} - {S}_{chp , n , t}^{U} - {S}_{chp , n , t - 1}^{U} ) \qquad ( 21 )$$
$$( {P}_{n , t}^{chp} + {c}_{v , n} {Q}_{n , t}^{chp} ) - ( {P}_{n , t - 1}^{chp} + {c}_{v , n} {Q}_{n , t - 1}^{chp} ) \leq {\underline{A}}_{n , t}^{chp} \cdot {S}_{chp , n , t}^{U} - {\underline{A}}_{n , t}^{chp} \cdot {S}_{chp , n , t}^{D} + {R}_{chp , n}^{U} ( {S}_{chp , n , t}^{O} - {S}_{chp , n , t}^{U} - {S}_{chp , n , t + 1}^{D} ) \qquad ( 22 )$$
$${P}_{n , t}^{chp} + {c}_{v , n} {Q}_{n , t}^{chp} \leq {\overline{A}}_{n , t}^{chp} \cdot ( {S}_{chp , n , t}^{O} - {S}_{chp , n , t}^{U} - {S}_{chp , n , t + 1}^{D} ) + {\underline{A}}_{n , t}^{chp} \cdot {S}_{chp , n , t}^{U} + {\underline{A}}_{n , t}^{chp} \cdot {S}_{chp , n , t + 1}^{D} \qquad ( 23 )$$
$$0 \leq {S}_{chp , n , t}^{O} \leq {S}_{chp , n} \qquad ( 24 )$$
$${S}_{chp , n , t}^{O} - {S}_{chp , n , t - 1}^{O} = {S}_{chp , n , t}^{U} - {S}_{chp , n , t}^{D} \qquad ( 25 )$$
$${S}_{chp , n} = {\sum }_{i = 1}^{{I}^{′}} ( {P}_{i , max}^{chp} + {c}_{v , i} {Q}_{i , max}^{chp} ) \qquad ( 26 )$$
wherein P_{n,t}^{chp} represents the electric power output of the CHP unit group n at t, Q_{n,t}^{chp} represents the heat power output of the CHP unit group n at t, c_{v,n} represents the parameter of the feasible operation region of the CHP unit, P_{n,t-1}^{chp} represents an electric power output of the CHP unit group n at t−1, Q_{n,t-1}^{chp} represents a heat power output of the CHP unit group n at t−1, A_{n,t}^{chp} and Ā_{n,t}^{chp} respectively represent ratios of a minimum output power and a maximum output power of the CHP unit group n at t to a total online capacity of the CHP unit group n, S_{chp,n,t}^{O} represents the total online capacity of the CHP unit group n, R_{chp,n}^{U} and R_{chp,n}^{D} respectively represent a climb-up rate and a climb-down rate of the CHP unit group n, S_{chp,n,t}^{U} represents a total start capacity of the CHP unit group n, S_{chp,n t}^{D} represents a total stop capacity of the CHP unit group n, S_{chp,n,t-1}^{U} represents a total start capacity of the CHP unit group n at t−1, S_{chp,n,t-1}^{U} represents a total stop capacity of the CHP unit group n at t−1, S_{chp,n,t+1}^{D} represents a total online capacity of the CHP unit group n at t−1, S_{chp,n,} represents a total capacity of the CHP unit group n, P_{i,max}^{chp} represents a maximum value of an output electric power of a CHP unit i in the CHP unit group n, Q_{i,max}^{chp} represents a maximum value of an output heat power of a CHP unit i in the CHP unit group n, and I′ represents the number of CHP units in the CHP unit group n;
the collaborative optimization model of the high-proportion new energy system based on CSP-CHP combined energy supply, comprising:
(1) objective function
the established high-proportion new energy system collaborative optimization model based on CSP-CHP combined energy supply has an objective of minimizing a total system cost of high-proportion renewable energy consumption, the objective function comprises a cost C_{coal} of a traditional coal-fired power generation unit, a cost C_{w} of the wind power generation unit, a cost Cₛ of the photovoltaic power generation unit, a cost C_{CSP} of the CSP unit, a cost C_{CHP} of the CHP unit, and a penalty cost C_{c} caused by abandoning wind and solar;
$$min C = {C}_{coal} + {C}_{w} + {C}_{s} + {C}_{CSP} + {C}_{CHP} + {C}_{c} \qquad ( 27 )$$
$${C}_{coal} = {\sum }_{m = 1}^{M} {a}_{coal , m} \cdot {I}_{coal , m} + {\sum }_{m = 1}^{M} {f}_{coal , m} \cdot {\overline{I}}_{coal , m} + {\sum }_{m = 1}^{M} {\sum }_{t = 1}^{T} {c}_{coal , m} \cdot {P}_{m , t}^{coal} \cdot Δ t + {\sum }_{m = 1}^{M} {\sum }_{t = 1}^{T} {st}_{coal , m} \cdot {S}_{coal , m , t}^{U} \qquad ( 28 )$$
$${C}_{w} = {a}_{w} \cdot {I}_{w} + {f}_{w} \cdot {\overline{I}}_{w} \qquad ( 29 )$$
$${C}_{s} = {a}_{s} \cdot {I}_{s} + {f}_{s} \cdot {\overline{I}}_{s} \qquad ( 30 )$$
$${C}_{CSP} = {\sum }_{j = 1}^{J} {a}_{csp , j} \cdot {I}_{csp , j} + {\sum }_{j = 1}^{J} {f}_{csp , j} \cdot {\overline{I}}_{csp , j} \qquad ( 31 )$$
$${C}_{CHP} = {\sum }_{n = 1}^{N} {a}_{chp , n} \cdot {I}_{chp , n} + {\sum }_{n = 1}^{N} {f}_{chp , n} \cdot {\overline{I}}_{chp , n} + {\sum }_{n = 1}^{N} {\sum }_{t = 1}^{T} {c}_{chp , n} \cdot ( {P}_{n , t}^{chp} + {c}_{v , n} {Q}_{n , t}^{chp} ) \cdot Δ t + {\sum }_{n = 1}^{N} {\sum }_{t = 1}^{T} {st}_{chp , n} \cdot {S}_{chp , n , t}^{U} \qquad ( 32 )$$
$${C}_{c} = {\sum }_{t = 1}^{T} {c}_{c} \cdot ( {P}_{t , max}^{w} - {P}_{t}^{w} ) + {\sum }_{t = 1}^{T} {c}_{c} \cdot ( {P}_{t , max}^{s} - {P}_{t}^{s} ) \qquad ( 33 )$$
wherein a_{coal,m}, f_{coal,m}, c_{coal,m}, and st_{coal,m}, respectively represent a new investment cost, a fixed operation and maintenance cost, a fuel cost, and a start-stop cost of the traditional coal-fired power generation unit, a_{w} and f_{w} respectively represent a new investment cost and a fixed operation and maintenance cost of the wind power generation unit, aₛ and fₛ respectively represent a new investment cost and a fixed operation and maintenance cost of the photovoltaic power generation unit, a_{csp,j} and f_{csp,j} respectively represent a new investment cost and a fixed operation and maintenance cost of the CSP unit, a_{chp,n}, f_{chp,n}, c_{chp,n}, and st_{chp,n} respectively represent a new investment cost, a fixed operation and maintenance cost, a fuel cost, and a start-stop cost of the CHP unit, C_{c} represents a penalty cost coefficient caused by abandoning wind and solar, I_{coal,m}, Ī_{coal,m}, P_{m,t}^{coal}, P_{m,t}^{coal}, and S_{coal,m,t}^{U} respectively represent a new capacity, a total capacity, an electric power output, and a start-stop capacity of the traditional coal-fired power generation unit, I_{w}, Ī_{w}, Pₜ^{w}, and P_{t,max}^{w} respectively represent a new capacity, a total capacity, an electric power output, and a maximum value of the electric power output of the wind power generation unit, Iₛ, Īₛ, Pₜ^{s}, and P_{t,max}^{s}, respectively represent a new capacity, a total capacity, an electric power output, and a maximum value of the electric power output of the photovoltaic power generation unit, I_{csp,j}, and Ī_{csp,j} respectively represent a new capacity and a total capacity of the CSP unit, I_{chp,j} and I_{chp,j} respectively represent a new capacity and a total capacity of the CHP unit, and M, J, and N respectively represent group numbers of the traditional coal-fired power generation unit, the CSP unit, and the CHP unit;
(2) constraint condition
(2-1) constraint of investment and operation decisions
$$0 \leq {P}_{m , t}^{coal} \leq {\overline{P}}_{m , t}^{coal} \leq {\overline{I}}_{coal , m} = {I}_{coal , m}^{0} + {I}_{coal , m} \qquad ( 34 )$$
$$0 \leq {P}_{t}^{w} \leq {α}_{t} \cdot {\overline{I}}_{w} = {α}_{t} \cdot ( {I}_{w}^{0} + {I}_{w} ) \qquad ( 35 )$$
$$0 \leq {P}_{t}^{s} \leq {β}_{t} \cdot {\overline{I}}_{s} = {β}_{t} \cdot ( {I}_{s}^{0} + {I}_{s} ) \qquad ( 36 )$$
$$0 \leq {P}_{j , t}^{csp} \leq {λ}_{t} \cdot {\overline{I}}_{csp , j} = {λ}_{t} \cdot ( {I}_{csp , j}^{0} + {I}_{csp , j} ) \qquad ( 37 )$$
$$0 \leq {P}_{n , t}^{chp} \leq {\overline{P}}_{n , t}^{chp} \leq {\overline{I}}_{chp , n} = {I}_{chp , n}^{0} + {I}_{chp , n} \qquad ( 38 )$$
wherein α₁, β₁, and λ₁ respectively represent hourly capacity factors of the wind power generation unit, the photovoltaic power generation unit, and the CSP unit, P_{m,t}^{coal}, P̅_{m,t}^{coal}, Ī_{coal,m}, I_{coal,m}⁰, and I_{coal,m} respectively represent an electric power output, an online capacity, a total capacity, an existing capacity, and a new capacity of the traditional coal-fired power generation unit group m at t, Pₜ^{w}, Ī_{w}, I_{w}⁰, and I_{w} respectively represent an electric power output, a total capacity, an existing capacity, and a new capacity of the wind power generation unit at t, Pₜ^{s}, Īₛ, Iₛ⁰, and Iₛ respectively represent an electric power output, a total capacity, an existing capacity, and a new capacity of the photovoltaic power generation unit at t, P_{j,t}^{csp}, Ī_{csp,j}, I_{csp,j}⁰, and I_{csp,j} respectively represent an electric power output, a total capacity, an existing capacity, and a new capacity of the CSP unit group j at t, and P_{n,t}^{chp}, P̅_{n,t}^{chp}, Ī_{chp,n}, I_{chp,n}⁰, and I_{chp,n} respectively represent an electric power output, an online capacity, a total capacity, an existing capacity, and a new capacity of the CHP unit group n at t;
(2-2) constraint of system electric power balance
$${\sum }_{m = 1}^{M} {P}_{m , t}^{coal} + {P}_{t}^{w} + {P}_{t}^{s} + {\sum }_{j = 1}^{J} {P}_{j , t}^{csp} + {\sum }_{n = 1}^{N} {P}_{n , t}^{chp} = {D}_{E , t} \qquad ( 39 )$$
wherein D_{E,t} represents an electric load demand of an energy system at t;
(2-3) constraint of system heat power balance
$${\sum }_{j = 1}^{J} {Q}_{j , t}^{TES , dis} + {\sum }_{n = 1}^{N} ( {Q}_{n , t}^{chp} - {Q}_{n , t}^{chp , cur} ) = {D}_{H , t} \qquad ( 40 )$$
wherein D_{H,t} represents a heat load demand of an energy system at t;
(2-4) system standby constraint
$${\sum }_{m = 1}^{M} {\overline{μ}}_{coal , m} \cdot {\overline{P}}_{m , t}^{coal} + {α}_{t} \cdot {\overline{I}}_{w} + {β}_{t} \cdot {\overline{I}}_{s} + {λ}_{t} \cdot {\sum }_{j = 1}^{J} {\overline{I}}_{csp , j} + {\sum }_{n = 1}^{N} {\overline{μ}}_{chp , n} \cdot {\overline{P}}_{n , t}^{chp} \geq {D}_{E , t} + {R}_{t}^{d} + {R}_{w} \cdot {P}_{t}^{w} + {R}_{s} \cdot {P}_{t}^{s} + {R}_{c} \cdot {\sum }_{j = 1}^{J} {P}_{j , t}^{csp} \qquad ( 41 )$$
wherein M, J, and N respectively represent group numbers of the traditional coal-fired power generation unit, the CSP unit, and the CHP unit, μ̅_{coal, m} and μ̅_{chp,n} respectively represent maximum output ratios of the traditional coal-fired power generation unit group m and the CHP unit group n at t, P̅_{m,t}^{coal} represents the online capacity of the traditional coal-fired power generation unit group m at t, αₜ, βₜ, and λₜ respectively represent the hourly capacity factors of the wind power generation unit, the photovoltaic power generation unit, and the CSP unit, Ī_{w} represents the total capacity of the wind power generation unit at t, Īₛ represents the total capacity of the photovoltaic power generation unit at t, Ī_{csp,j} represents the total capacity of the CSP unit group j at t, P̅_{n,t}^{chp} represents the online capacity of the CHP unit group n at t, D_{E,t} represents the electric load demand of the energy system at t, Pₜ^{w} represents the electric power output of the wind power generation unit at t, Pₜ^{s} represents the electric power output of the photovoltaic power generation unit at t, and P_{j,t}^{csp} represents the electric power output of the CSP unit group j at t;
Rₜ^{d} represents a standby requirement related to the electric load demand at t, and R_{w}, Rₛ, and R_{c} respectively represent prediction errors of output powers of the wind power generation unit, the photovoltaic power generation unit, and the CSP unit;
(2-5) constraint of low-carbon policy
$${P}_{t}^{w} + {P}_{t}^{s} + {\sum }_{j = 1}^{J} {P}_{j , t}^{csp} \geq r \cdot {D}_{E , t} \qquad ( 42 )$$
wherein r represents a proportion of a renewable energy power generation in a total power generation, Pₜ^{w} represents the electric power output of the wind power generation unit at t, Pₜ^{s} represents the electric power output of the photovoltaic power generation unit at t, P_{j,t}^{csp} represents the electric power output of the CSP unit group j at t, and D_{E,t} represents the electric load demand of the energy system at t;
acquire operating parameters of various units, cost data of various units, and wind and solar resource data of a planned region, inputting the acquired operating parameters of various units, cost data of various units, and wind and solar resource data of the planned region into the high-proportion new energy system collaborative optimization model based on CSP-CHP combined energy supply, and solving the high-proportion new energy system collaborative optimization model based on CSP-CHP combined energy supply to obtain optimized capacity configurations of various units in the high-proportion new energy system; and
a display device, to display a final capacity planning and operation optimization scheme of the various units in the high-proportion new energy system formed by the obtained optimized capacity configurations of the various units in the high-proportion new energy system, so as to conduct an adjustment of capacities of the various units in the high-proportion new energy system if the capacities do not match the obtained optimized capacity configurations, to maintain a capability of energy supply of the high-proportion new energy system.
